(19) United States
(12) Patent Application Publication
(10) Pub. No.: US 2021/0279688 A1
(43) Pub. Date: Sep. 9, 2021

(54) AI PLATFORM WITH REAL-TIME ANALYTICS AND SOCIAL INCENTIVE REFERRALS

(71) Applicant: Srinivasa Rao Boddapu, Austin, TX (US)

(72) Inventor: Srinivasa Rao Boddapu, Austin, TX (US)

(21) Appl. No.: 17/250,335

(22) PCT Filed: Jul. 23, 2019
(86) PCT No.: PCT/US19/43018

§ 371 Date: Jan. 6, 2021

Related U.S. Application Data
(60) Provisional application No. 62/702,068, filed on Jul. 23, 2018.

(51) Int. Cl. G06Q 10/10; G06Q 10/06; G06Q 30/02

(52) U.S. Cl. CPC G06Q 10/1053; G06Q 30/0217; G06Q 10/063112

(57) ABSTRACT

A system for providing a platform with real-time analytics and social incentive referrals to assist with recruiting of talent to a company. The system includes candidate to position matching and referral incentives to identify higher quality candidates for each position listing. In some cases, the system may provide recommendations to either the candidate or the listing company to improve the hiring process and candidate matching.

### CROSS-REFERENCE TO RELATED APPLICATIONS

This application is a U.S. national stage application under 35 USC § 371 of International Application No. PCT/US19/43018 filed on Jul. 23, 2019 and entitled “AI PLATFORM WITH REAL-TIME ANALYTICS AND SOCIAL INCENTIVE REFERRALS,” which claims priority to U.S. Provisional Application No. 62/702,068 filed on Jul. 23, 2018 and entitled “AI PLATFORM WITH REAL-TIME ANALYTICS AND SOCIAL INCENTIVE REFERRALS,” which is incorporated herein by reference in their entirety.

### BACKGROUND

As the population of the world continues to grow and become more mobile, job openings will continue to have an increasing number of job applicants. The larger number of job applicants requires more time of recruiters and human resource employees in the hiring process. Additionally, listing a position has become increasingly complex and expensive as the number of websites and platforms has grown considerably. Unfortunately, the increase of applicants and job listing sites has not resulted in better matches for both parties. matching quality applicants having skills that match the position requirements

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example system for ranking candidates and social tracking of referrals according to some implementations.

FIG. 2 illustrates an example system for sharing positions according to some implementations.

FIG. 3 illustrates an example system for tracking a referral chain associated with an instance of a position according to some implementations.

FIG. 4 illustrates another example system for tracking a referral chain associated with an instance of a position according to some implementations.

FIG. 5 illustrates example timing diagram associated with generating a candidate list according to some implementations.

FIG. 6 is example flow diagram showing an illustrative process for identifying a candidate list according to some implementations.

FIG. 7 is example flow diagram showing an illustrative process for distributing funds associated with a referral chain according to some implementations.

FIG. 8 is another example flow diagram showing an illustrative process for distributing funds associated with a referral chain according to some implementations.

FIG. 9 illustrates example components of one or more servers associated with the recruiting system according to some implementations.

FIG. 10 illustrates example components of a device hosting a user or client side application associated with the recruiting system according to some implementations.

FIG. 11 illustrates example components of one or more servers associated with the company system hosting a portal associated with the recruiting system according to some implementations.

FIG. 12 illustrates an example user profile according to some implementations.

FIG. 13 illustrates an example company portal according to some implementations.

FIG. 14 illustrates an example view of a user portal according to some implementations.

FIG. 15 illustrates an example reference request view of a user portal according to some implementations.

FIG. 16 illustrates an example detailed view of a user portal according to some implementations.

FIG. 17 illustrates an example summary view of a user portal according to some implementations.

FIG. 18 illustrates an example account information view of a user portal according to some implementations.

FIG. 19 illustrates another example account information view of a user portal according to some implementations.

FIG. 20 illustrates an example position search view of a user portal according to some implementations.

FIG. 21 illustrates an example incentive payment view of a user portal according to some implementations.

FIG. 22 illustrates an example position application view of a user portal according to some implementations.

FIG. 23 illustrates another example position application view of a user portal according to some implementations.

FIG. 24 illustrates yet another example position application view of a user portal according to some implementations.

FIG. 25 illustrates yet another example position application view of a user portal according to some implementations.

FIG. 26 illustrates yet another example position application view of a user portal according to some implementations.

FIG. 27 illustrates an example detailed view of a position posting according to some implementations.

FIG. 28 illustrates another example detailed view of a position posting according to some implementations.

FIG. 29 illustrates yet another example detailed view of a position posting according to some implementations.

FIG. 30 illustrates yet another example detailed view of a position posting according to some implementations.

FIG. 31 illustrates yet another example detailed view of a position posting according to some implementations.

FIG. 32 illustrates an example pending position status view of a user portal according to some implementations.

FIG. 33 illustrates an example pending position status view of a user portal according to some implementations.

FIG. 34 illustrates an example referral view of a user portal according to some implementations.

FIG. 35 illustrates an example view of a customer portal according to some implementations.

FIG. 36 illustrates an example dashboard view of a customer portal according to some implementations.

FIG. 37 illustrates a calendar view of a customer portal according to some implementations.

FIG. 38 illustrates an example position detail view of a customer portal according to some implementations.

FIG. 39 illustrates another example position detail view of a customer portal according to some implementations.

FIG. 40 illustrates an example interview scheduling view of a customer portal according to some implementations.

FIG. 41 illustrates an example position posting view of a customer portal according to some implementations.

FIG. 42 illustrates an example position posting view of a customer portal according to some implementations.

FIG. 43 illustrates an example interview schedule view of a customer portal according to some implementations.

FIG. 44 illustrates an example position detail view of a customer portal according to some implementations.

FIG. 45 illustrates another example position detail view of a customer portal according to some implementations.

FIG. 46 illustrates yet another example position detail view of a customer portal according to some implementations.

FIG. 47 illustrates a position creating view of a customer portal according to some implementations.

FIG. 48 illustrates another position creating view of a customer portal according to some implementations.

FIG. 49 illustrates yet another position creating view of a customer portal according to some implementations.

FIG. 50 illustrates yet another position creating view of a customer portal according to some implementations.

FIG. 51 illustrates a personality trait selection view of a customer portal according to some implementations.

### SUMMARY

This disclosure includes techniques and implementations for providing a system and platform with real-time analytics and social incentive referrals. For instance, discussed below are various examples of features and benefits of the system for both a candidate and a hiring company.

For example, the system may be configured to pay a hiring bonus if the candidate accepts a job through the system. The size of the bonus may be a percentage of the compensation that the candidate receives in their new position.

In some cases, the candidate will have access to data including public and private school rankings, property tax rates, cost of living, crime rate, public transportation, and a listing of parks and recreational offerings within a specified radius of the job location. The data may further be refined to include details which are prompted by personal characteristics in the candidate's personal profile.

In one instance, if the candidate completes a personality assessment such as the DISC (Dominance, Influence, Compliance, and Steadiness) assessment, Big Five or OCEAN (Conscientiousness, Agreeableness, Neuroticism, Openness, Extraversion/Extroversion) to determine the candidate's personality category, the results are applied to each position the candidate explores and a percentage revealing the extent to which the candidate matches the ideal personality for each position may be generated. The matching scores allows the candidate to find and evaluate each potential position. In this manner, the candidate may apply for the jobs that most celebrate the candidate strengths, support the core of who the candidate is, and are the most likely to be selected for.

In some examples, the system integrates real-time processing to keep the candidate aware of everything that is happening in the application process with the latest status updates for each potential position or any new potential position. Thus, as the process unfolds, the candidates are not only granted access but actually encouraged to communicate directly with hiring managers. For example, the system may provide suggestions to the user on when to contract the hiring manager and what topics to focus the discussion on. In this way, the system may expedite the hiring process for both parties to address nuanced details that may inevitably be deal-breakers which is incredibly useful to know before much time is invested. For example, the system may provide suggested salary and benefit negotiation tips. In one specific example, the system may utilize machine learning (e.g., neural networks, deep learning, regression techniques, etc.), cloud computing, or other computer learning and data aggregation tools to suggest potential positions, discussion topics, discussion points, and negation points for each candidate. For instance, the system may utilize personal data, such as the candidates DISC assessment or OCEAN assessment scores or other data provided by the user's profile, together with aggregate hiring data to generate the suggestions. In some cases, voice-activated technology gives the candidate the added flexibility of not being tied to a keyboard.

In one implementation, the system allows the candidate to gain valuable insight about themselves through the eyes of one who has worked in the exact position. For example, the system includes first-hand testimony in the form of likes, dislikes, reviews, and overall ratings from those who have worked in the actual position. This information from those with direct experience is an invaluable resource empowering the candidate to move forward with a potential position.

The system also has analytically assisted search feature. The search option is configured to manage alerts, save searches, and perform tasks based on personal preferences. In some cases, the system may drive the searches on behalf of the candidate using data collected from the candidate's profile, activity on the site, personal preferences, and what is currently trending in the hiring market.

In some cases, the system offers the candidate the ability to track their application history, determine their position among others applying for the same position, manage their interview schedule and personal preferences, investigate suggested jobs based on the candidate profile, and browse the latest information that is trending in real-time.

In some cases, personal references of coworkers, associates, and friends are chosen by the candidate. They complete a questionnaire indicating how they view the candidates personal value system. In some examples, the system may identify and request the references on behalf of each candidate to provide more reliable reference data to the hiring party and, thereby, giving each candidate an improved probability of being selected for a particular position.

The system also allows the candidate to shine as bright as possible with the most individualized, unique profile in the market. In some cases, a candidate or user may upload a resume and the system may parse the text and extract data for the job application process. The system produces a new summary for each job to which the candidate applies based on the extracted data.

In some case, a match machine or system calculates the candidate profile match percentage inspired by the candidate's skills, business domain, location, culture and values match for each position. It continually incorporates data that unfolds between the candidate profile and solicited jobs and makes suggestions for the candidate to increase the candidate's percentile match before the candidate applies. This information is shared with hiring leaders in real-time which puts you ahead of the competition.

In one example, a blog and discussion forum may be included as a place to find and share real-time data on topics that most interest the candidates. The topics range from the latest technological innovations to biographical stories to questions and/or answers about hot button topics with industry leaders offering invaluable insights based on their personal experience.

The platform offers hiring leaders a simple, modern, and cost-effective experience. The platform is a clean, modern, and streamlined map. Hiring leaders will find screens with easy, straightforward access to what the hiring manager or leader needs. For example, the system includes an unique style of posting with the help of real-time analytics to assist the hiring manager in completing the position or job posting. The dashboard, job wall, decision-making summary or snapshot profile, and real-time updates offer a one-stop solution to monitor each job's activity.

In some cases, the platform or system provides background, reference, and skills verifications for hiring leaders. The platform makes sure that each candidate passes our Impeccable Profile. When hiring leaders are reading the qualifications of a potential candidate that seems like a perfect match, the system is able to verify that the information received regarding the candidate and the candidates profile is true and accurate.

In some cases, the platform provides a video sizzle or interview. Unlike words on a page, a 30-45 second video tailored may be created by or uploaded to the platform or system for each posting allows the jobs to sizzle with real life footage of assignments in action. Hiring leaders film the actual location of the project, shoot footage of tasks being accomplished, and capture short interviews of employees giving testimonials to enhance the posting. Hiring leaders also review Video Sizzle furnished by applicants presenting why they are the best fit.

The platform provides real-time job reviews to give hiring leaders invaluable information and transparent insights for each job post. Reviews by the candidates include likes, dislikes, and feedback of the posted job empowering hiring leaders to make ongoing, appropriate decisions. This completely unique constructive criticism results in the refinement of job details leading to an expanded target audience.

The platform also has a virtual recruiting assistant cross-references data of the applicant pool with details of the position to produce far-ranging analytics. The virtual recruiting assistant works nonstop to give hiring leaders the more meaningful data to streamline the hiring process, stay informed of the number of viable candidates, and accordingly plan their budget.

In some implementations, the system provides analytically guided posts that reveal to the available candidates, average compensation, demographic meta-data, and the latest trending data. Voice-enabled features guide hiring leaders through a supremely streamlined interaction revealing information that is tailored to the job. The analytics assist hiring leaders to make the best, quickest, most accurate posts possible. Hiring leaders also can choose from our list of analytically guided, behavioral interview questions which assess aspirational attitudes to gain an initial glimpse of the applicant.

In some case, the platform has an intelligent match machine that calculates the match percentage inspired by applicant skills, business domain, location, culture and values match for each position. In one example, the intelligent job match machine or process of the platform allows the hiring leaders or job posters to dynamically change one or more parameters of a position and/or close/open a position based on a timer, in real-time, or upon various criteria or thresholds.

In some implementations, the platform may have a hiring predictor that gives hiring leaders the realistic likelihood of hiring and the average timeline for the hiring to unfold. Based on data such as the job requirements, length of assignment, quarter of the year, and geographical location compiled from all previous hires, the platform provides hiring leaders with the most likely prediction of the process.

The platform may also include a job wall with useful information representing the entire life of the posting. It includes the number of views, suggested profiles, likes and dislikes, hires, withdrawals, and rejections. Each candidate has a display revealing a decision summary, skill rating, personality fit, technical screening, and background and reference verification information. Without spending much time, hiring leaders can quickly scan through this condensed version of the candidate.

The platform also includes an interview platform immediately gets the hiring ball rolling. A list of third party interview specialists who are subject matter experts are chosen by hiring leaders saving a huge amount of time and increasing quality. It includes a rating system of the specialists, the specialist's areas of expertise and fees, and an historical database of their previous interviews allowing hiring leaders to choose the highest rated individuals to participate in the selection process. A complete log is kept of all interviews for hiring leaders to review and provide ratings of the individuals who are part of the hiring leader's hiring process. The rating system inherently raises the quality of specialists as the specialist's compensation is directly correlated to the specialist's rating by the platform.

In some implementations, bots or web-crawlers of the system collect third party data usable to match candidates passively with employers. In some cases, the third-party data may be collected from social media. In addition, the platform includes incentivized referrals that expand the pool of matching candidates speeding up the hiring process.

### DETAILED DESCRIPTION

This disclosure includes techniques and implementations for providing a system and platform to allow for social sharing of job or position postings. For example, conventional job listing sites and platforms are candidate driven (e.g., a company lists a position and the candidates are required to apply). However, by allowing the candidates to drive the application process, the applicants often lack the required skill sets and quality candidates may fail to apply. For example, often individuals apply for an open position even when the applicant has the upfront knowledge that they are not fully qualified, or lack skills required of the job. In these cases, the applicant may be hopeful that they are the most qualified applicant or that if selected, the position would be a good career move or advancement. This situation results in recruiters, company management personal, and company human resource personal to spend valuable resources and time sorting out unqualified candidates from the application pool.

On the other hand, quality candidates often fail to apply for a position even when in the market. The plurality of job listing sites available today often requires job seekers to selectively utilize only a few of the available platforms as the time required to sort through job descriptions is limited. Thus, the conventional system and platforms for career services has increased the costs associated with identifying and hiring quality candidates.

The system and platform, described herein, may be configured to allow a candidate or job seeker to create a candidate profile within the system. For example, the candidate may provide or upload a resume, employment history, certifications, clearances, qualifications, and other career related information into the candidate profile. When the resume is updated, the system may parse the information such as, employment history, certifications, clearances, qualifications, and other career related information into the candidate profile.

In some cases, the system may request the candidate provide specific information (e.g., answer questions) or complete additional worksheets to gather information about the candidate relevant to one or more open positions. In one specific example, the system may allow the user to apply for background checks or other certifications to improve the individual's qualifications for one or more open position.

Once a candidate has created a profile, the system may rank or score various qualifications of the candidate. In some cases, the ranking or scoring may be performed per open position. For example, the system may rank or score the candidate for each open position by comparing the candidate's qualifications to a job description or qualification list. In some instances, the system may generate the qualification list or scoring metrics based on information entered by a company when the open position is posted to the system.

In some examples, the system may provide the user with a list of open positions the system believes are a good fit for the user. For example, any position in which the user scores over a threshold may be presented to the user. In other examples, a predetermined number of open positions may be presented to the user. For instance, the top 5, 10, 15, 20, 25, or another desired number of candidates open positions may be presented (e.g., the top or best matches between open position and user qualifications). In some cases, the user may provide feedback on the list of positions to assist the system in determining positions that are a good match. In one particular implementation, the system may also provide feedback or suggestions to the user on improvements to the user profile or additional certifications/skills that would increase the candidates score for a particular open position or type of position. For example, by pre-passing a background check the user may be more appealing to a particular type of position. In some examples, candidates may maintain their background verification details for a certain period of time (e.g., the background verification may expire after the period of time elapses). During the period of time on our system, the customers may view active background verified candidates. Customers and/or candidates can always request more background verification by paying extra fees to our system. In some cases, the customer may request the background check, personality test, and/or technical evaluation of the user prior to applying to a position.

The system may also utilize the user profile to open position ranking or scoring to reduce the number of applicants a particular company may have to review during the hiring process. For example, the system may allow the user to apply, re-apply, or improve the application for a particular open position for a period of time. Once the period of time has elapsed, the system may determine a final ranking of the candidate (e.g., users that applied) and provide a predetermined number of candidate (such as 5, 10, etc.) to the company or hiring leader. Since the candidates are ranked based on the desired skills, qualifications, certification, and career history the company specified when the position was created, the highest ranking candidates are also the most qualified. In some examples, the company may provide feedback on the list of candidates received. For instance, if all of the candidates are missing a required skill set, the company may add the skill to job description or open position and allow the system to re-rank the candidates that applied for the position. In some cases, the system may allow the system to solicit or collect additional applications based on the updated criteria. In this manner, the company may with relative low time investment quickly dial-in on candidates with the desired qualifications.

In some examples, in addition to inviting candidates to apply for open positions that the candidates are highly qualified for, the system may also allow users to refer or share position listings between users or with individuals via various social media or other electronic platforms. In some cases, the system may track the sharing of the open position. For example, the system may utilize information known about the individual sharing the open positions with regards to ranking the candidate whom applied for the open position. For instance, if the referring individual often recommends candidate that score highly with respect to the particular open position, candidates that are often selected for interviews, or candidates that are often hired to fill the position, the sharing individual may result in the candidate receiving a higher score or ranking with respect to the referred position.

In some cases, in addition to sharing an open position listing with candidates whom profile results in a high score or good match, the system may also provide the open position listing to various individuals that have recommended or referred quality candidates for similar positions in the past. In this manner, the system may enable high quality candidates via networking, referrals, or individual to individual relationships, which often result in better higher quality candidate and more hires.

In some examples, the system may track a referral chain associated with an open position. The system may utilize block chain or other even tracking processes and/or techniques to determine the referral chain. For example, a first user may be presented with an open position that results in a match greater than a threshold between the first user's profile and the position listing. However, the first user may have recently accepted a position with another company. In this example, the first user may forward the open position listing to a second user that the first user knows is looking for a similar position. In this example, the system may store the referral between the first user and the second user. In some instances, the second user may also have accepted a position and recommend a third user for the position. The referrals may continue such that, for example, a ninth user applies to the positions (e.g., the ninth user only received the open position via 8 previous referrals).

In this example, the system may consider the quality of the eighth user when ranking the ninth user for the position as the eighth user provided the direct. In some cases, the system may also consider the quality of the first candidate when ranking the ninth user for the position, as the first user initiated the referral that resulted in the application. In addition, to utilizing the referral chain to provide input to the ranking of the ninth user (e.g., the user that applied for the position), the system may utilize the referral chain to award a commission or payment to the individuals recommending users. For example, the system may provide a commission or payment to one or more of the users within the referral chain for an applicant that is actually hired to fill the open position they were recommended for. In one example, the system may provide a commission to the individual that commenced the referral chain (e.g., the first user) as well as the individual responsible for the direct (e.g., the eight user).

In some implementations, the system may also provide a commission or payment to an individual that recommended a candidate that was provided as part of the candidate list to the company, the individual that recommended the highest-ranking candidate provided to the company, and/or the individual that recommended the largest number of candidates provided to the company. In this manner, the system may encourage individuals to recommend quality candidates.

Thus, the system and platform discussed herein, is an improvement to over conventional recruiting platforms, as the system is not reliant on applicant-initiated submissions. For example, the system selects the candidates or invite users to apply based on the user profiles of each job seeker on the platform and the criteria for each open position listing. Further, the system provides a reduced list of qualified or most qualified candidates to the company as the candidates are ranked or scored prior to submitting the candidate list to the company. The system also encourages per recommendation of candidate for open positions to improve quality of candidates via the referral chain and commission structure. In some case, the system may provide feedback or recommendation to both the company and the candidates to achieve a better match on both sides of the hiring equation.

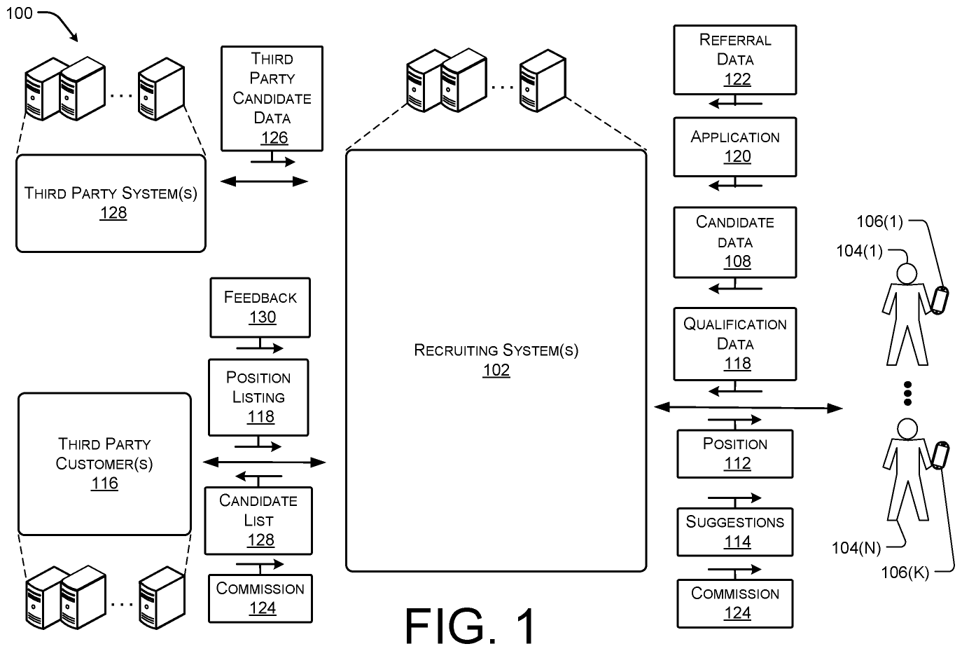

FIG. 1 illustrates an example system 100 for ranking candidates and social tracking of referrals according to some implementations. The illustrated example includes a recruiting system 102 that hosts the recruiting platform discussed herein. One or more users 104(1)-(N) (e.g., job candidates, past candidates, users, or other individuals) may access the recruiting system 102 via one or more applications operating on one or more devices 106(1)-(K).F example, the users 104 may upload candidate data 108 (such as resume and career history), other qualification data 110 (such as certifications and background check data) as well as receive data related to open positions 112.

The recruiting system 102 may utilize the candidate data 108 and the qualification data 110 to generate a candidate profile and/or to rank or score a user 104 with respect to one or more open positions 112. In the situation that a user 104 scores or ranks highly with respect to a particular opening, the system 102 may provide the position 112 or data associated with the position 112 to the user 104. In some cases, the recruiting system 102 may request that the user 104 apply to the position 112. In some cases, the recruiting system 102 may provide feedback or suggestions 114 to the user's devices 106, such that the user 104 may improve the overall score and/or ranking with respect to the particular position 112 the user is applying for. For example, the recruiting system 102 may request that the user 104 take a particular test or obtain a particular certification prior to the close of the application period with respect to the position 112. Thus, it should be understood that the user 104 may submit an application 120, receive suggestions 114 or feedback from the recruiting system 102, and re-file the application 120 by updating and resubmitting the application 120, providing additional candidate data 108 or qualification data 118, or otherwise updating the user's candidate profile at the recruiting system 102.

A third-party customer 116 may also access the recruiting system 102 to post position listings 118 (e.g., one or more open positions with the third-party customer 116). In some cases, the position listings 118 may include a list of required skills, a job description, number of years' experience, a time period of deadline for application, a particular DISC or OCEAN assessment score, personality, background, and/or drug testing expectation and results, etc. Once the recruiting system 102 receives the position listing 118, the recruiting system 102 may rank each possible user 104 based on the candidate profiles. The recruiting system 102 may then provide a notification of or request for the selected users 104 to apply to the position, such as position 112. In some cases, the selected users 104 may have achieved a score over a predetermined threshold. In some cases, the threshold may be provided as part of the position listing 118, while in other cases, the recruiting system 102 may generate the threshold based on the data associated with the position listing 118. In some cases, the third-party customer 116 may be a company, hiring leader, hiring manager, recruiter, or other individual or entity posting a position listing 118 with the recruiting system 102.

In some situations, the user 104 may submit an application 120 to the position 112 in response to receiving the notification. In other situations, the user, such as user 104(1), may referral 122 the position 112 with another user or individual, such as user 104(2). In this example, the recruiting system 102 may track or maintain a chain of share or referral chain (such as a chain of title). The referral chain may maintain a list of whom users 104 referred the position 112 with through various levels of referrals until a candidate list 124 is selected and sent to the third-party customer 116 or a candidate is selected to fill the position 112.

In some cases, the recruiting system or platform 102 may utilize the referral chain to award a commission, incentive, or payment to the users 104 that referred 122 the position 112 with a candidate (e.g., a user's 104 that applied for the position 112). For example, the recruiting system 102 may provide a commission 124 or payment to one or more of the users 104 within the referral chain of a candidate that is hired to fill the open position 112. In one example, the recruiting system 102 may provide the commission 124 to the user 104 that commenced the referral chain as well as the user 104 responsible for the direct referral to the selected candidate. In some cases, the commission 124 paid to different users 104 within the referral chain may vary based on position within the referral chain.

In some examples, the recruiting system 102 may also access or receive third party candidate data or information 126 about each candidate and/or user 104 from a third-party system 128. For example, the recruiting system 102 may access social media accounts, other third party recruiting systems, past employer websites, etc. to obtain information related to each of the candidates and/or users 104. In some cases, the third-party candidate data or information 126 may be used to rank or score the candidates for the position 112. For instance, the social media account of a candidate may indicate that the candidate 104 is part of a volunteer organization that may relate to the position 112 causing the candidates score or rank to increase. Alternatively, the candidate's social media accounts may indicate that the candidate worked for less time at a particular company than the candidate data 108 provided by the candidate which may cause the candidates score or rank to be decreased with respect to the position 112.

Once the applications 120 and the third-party candidate data 126 for each candidate is received, the recruiting system 102 may rank the candidates based on the candidate profile (generated from the candidate data 108 and the qualification data 118) and the third-party candidate data 126 to generate a candidate list 128. The candidate list 128 may include a final ranking of the candidates that submitted an application to the position 112. In some cases, the candidate list 128 may include a limited number of the candidates, such as the top 2, 3, 5, 10, 15, 20, or 25 (or some number between 1-50) candidates 104 that applied for the position 112. The candidate list 128 may then be provided to the third-party customer 116. In some cases, in response to providing the candidate list 128 or the selection of a candidate to fill the position 112 from the candidate list 128, the third-party customer 116 may send the commission 124 to the recruiting system 102. The recruiting system 102 may then distribute at least a portion of the commission 124 to various users 104 based on the referral chain associated with the candidates on the candidate list 128 and/or on the selected candidate.

In some particular examples, the third-party system 116 may fail to select a candidate from the candidate list 128. In these examples, the third-party customer 116 may provide feedback or additional information 130 to the recruiting system 102, such that the recruiting system 102 may updated the scoring and generate a new candidate list that may be provided to the third-party customer 116. In some cases, the recruiting system 102 may also provide additional predetermined number of candidates in response to a request by the third-party customer 116. For example, if no one in the top 10 candidates as scored by the recruiting system 102 was selected by the third-party customer 116, the recruiting system 102 may send the next top 10 candidates to the third-party customer 116.

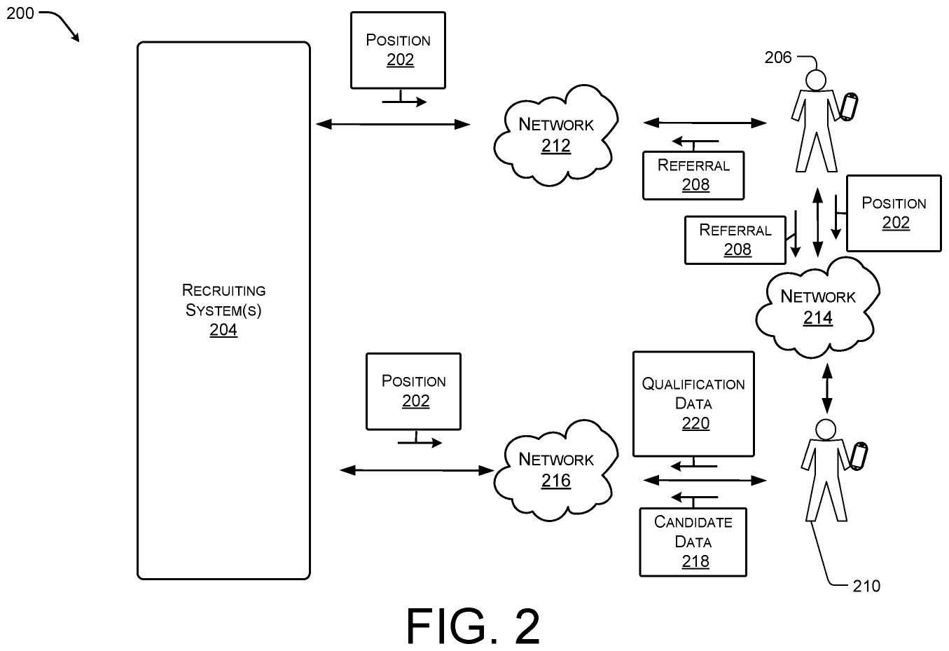

FIG. 2 illustrates an example system 200 for referring positions, such as position 202, according to some implementations. In the illustrated example, a recruiting system 204 may receive a position listing 202 from a company, recruiter, or hiring manager. The recruiting system 204 may score users, such as user 206, having candidate profiles within the recruiting system 204. As discussed above, the scores may be used to identify users that may be a good fit or should otherwise apply to the position 202 and/or to rank candidates for including in the candidate list provided to the company, recruiter, or hiring manager.

In the illustrated example, the user 206 may view the position 202 and determine that they are not interested in the position 202. In this case, the user 206 may referral 208 the position 202 with a second individual 210. In some cases, the second individual 210 may be a user of the recruiting system 204. In this case, the referral 208 may be sent back to the recruiting system 204, for instance via a network 212 (e.g., the Internet®). The recruiting system 204 may then record the referral 208 in the referral chain of the position 202 and send the position data 202 to the individual 210 requesting the individual 210 to apply.

In other instances, the individual 210 may not have an account with the recruiting system 204. In this example, the user 206 may referral 208 the position 202 with the individual 210 via various third-party systems or platforms, such as social media, email, text message, etc. For example, the user 206 mays end the data associated with the position 202 to the individual 202 as an email over a network 214. In this case, the referral 208 may also be provided back to the recruiting system 204, such that the recruiting system 204 may note the referral in the referral chain. In other cases, the instance of the position 202 may include a code or otherwise track the referral 208 (for instance, via block chain technology).

In this instance, the individual 210 may receive the position 202 and decide to apply. In this case, the individual 210 may become a user of the recruiting system 204 by sending (for example, via network 216) candidate data 218 and qualification data 220 to create a candidate profile. The individual 210 may also provide a request to apply to the position 202 once the candidate profile is complete.

In the current example, networks 212-216 are shown as different networks. However, it should be understood that, in some cases, the networks 212-216 may be the same.

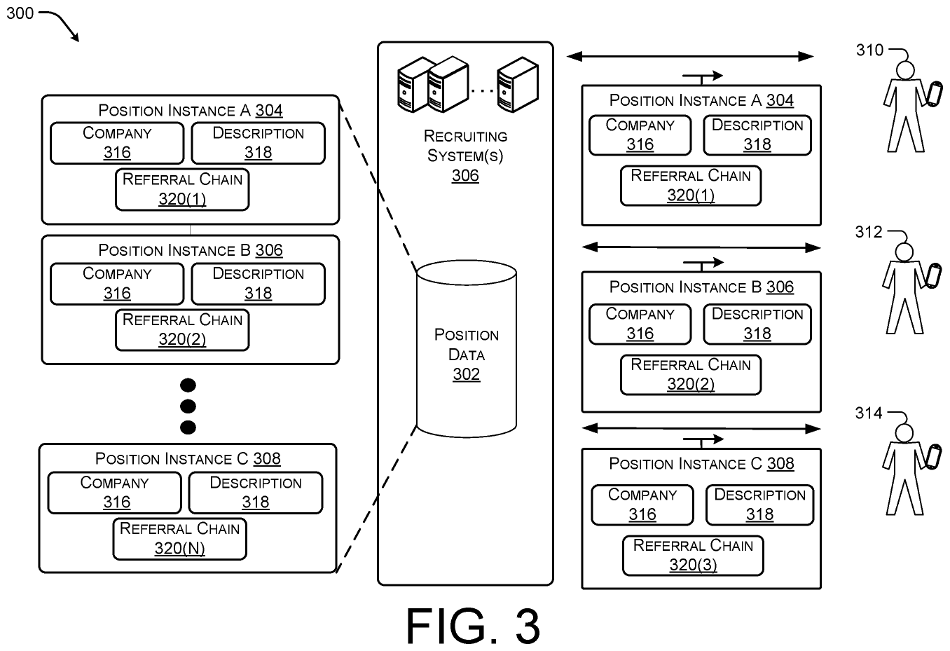

FIG. 3 illustrates an example system 300 for tracking a referral chain associated with an instance of a position according to some implementations. As discussed above, the recruiting system 302 may allow companies to post position listings in order to receive a candidate list of scored or ranked candidates in return. In some examples, the recruiting system 302 may allow users of the system 302 to refer positions with other users. In this manner, the recruiting system 302 may generated multiple instances, such as instance 304, 306, and 308, of a position and send a different instance to each user, such as users 310, 312, and 314, the recruiting system 302 desires to apply to the position.

For example, the recruiting system 302 may receive a position listing from a company and identify the users 310, 312, and 314 are being good potential candidates or fits for the position. The system 302 may then generate instances of the position to send to each of the users 310-314. For instance, the position instance 304 may be sent to the user 310, the position instance 306 may be sent to the user 306, and the position instance 308 may be sent to the user 314. In this manner, each user 310-316 may have an instance of a position that may be referred, forwarded, or otherwise provided to additional users and/or other individuals while maintain a referral chain or chain of title. In the current example, each position instance 304-308 may include information on the company 316, the descriptions of the position 318, and a referral chain 320. As shown in the illustrated example, the company 316 and the descriptions of the position 318 may be the same or similar with respect to each instance 306-308 but the referral chain 320 may vary from instance to instance. Thus, the recruiting system 302 may track the referral chain 320 with respect to each instance of the position in order to distribute the commission to the correct users 310-314.

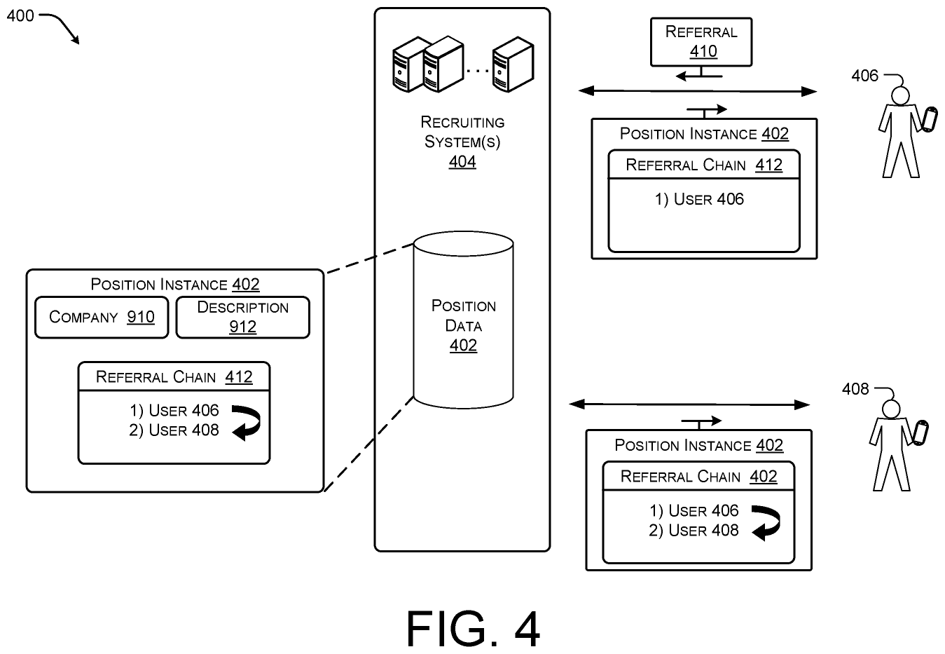

FIG. 4 illustrates another example system 400 for tracking a referral chain associated with an instance 402 of a position according to some implementations. In the current example, a recruiting system 404 may receive a position listing from a company and identify the user 406 as being potential candidates for the position. The recruiting system 404 may then generate instance 402 of the position to send to the user 406.

In the current example, the user 406 may decline the offer to apply for the position represented by the instance 402. However, the user 406 may recommend user 408 as a potential candidate. Thus, the user 406 may referral 410 the instance 402 of the position with the user 408. In this example, the instance 402 may update a local referral chain 412 to indicate that the user 402 referred 410 the instance 402 with the user 408. The recruiting system 404 may then send the instance 402 to the user 408, whom may apply for the position or further refer the instance 402.

In the current example, the position instance 402 may be updated and maintained as part of position data 414 stored with respect to the recruiting system 404 or stored as part of the data associated with the instance 402 itself (for example, via a block chain technology). In this manner, the recruiting system 404 may then distribute a portion of a commission received in response to placing a candidate with the company.

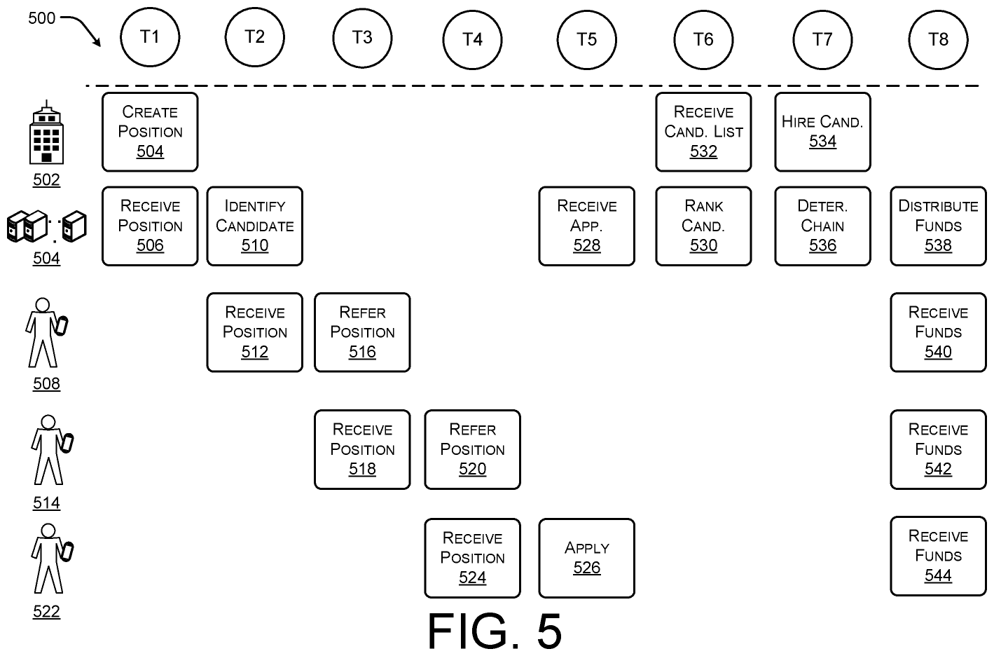

FIG. 5 illustrates example timing diagram 500 associated with generating a candidate list according to some implementations. In the current example, at time T1, a company 502 may access the recruiting system 504 to generate or create a position 504. The recruiting system 504 may receive the position data 506 and in response generate a position or position instance to distribute to one or more users. For example, the recruiting system 504 may convert the position data, such as the job description, desired skills, work history requirements, etc., into one or more criteria that may be used to score a candidate fit with respect to the open position.

At time T2, the recruiting system 504 may identify one or more users, such as user 508, that may be a good potential candidate for the position 510. For example, the system 504 may score user 508 with respect to the criteria associated with the open position. In some cases, if the user 508 scores above a threshold then the recruiting system 504 may notify then user 508. Thus, at time T2, the recruiting system 504 may send and the user 508 may receive data associated with the position 512.

In the current example, the user 508 may review the position 512 and determine that another user, such as user 514, may be a potential candidate for the position. In this case, at time T3, the user 508 may refer the position 516 and the user 514 may receive the position 518. The user 514 may also review the data associated with the position and determine that a user 520 may be a potential candidate for the position. Thus, at time T4, the user 514 may refer the position 520 and the user 522 may receive the position 524.

The user 522 may then apply 526 for the position. For instance, the user 522 may apply by submitting an application, by completing one or more forms, causing the user 522 to complete a questioner, and/or by selecting an apply button. For example, the system 504 may generate the application for the user 522 from the user profile, third party information about the user 522, and/or additional data provided by the user 522. Once the user 522 submits the application, the application may be received 528 by the recruiting system 504.

Once the application period has expired and at time T6, the recruiting system 504 may rank the candidates 530 to generate a candidate list. For example, the recruiting system 504 may score each candidate based on the criteria associated with the position and the user information known about each candidate. The user information may include the user profile, third party data, user submitted data, etc. The candidate list may then be sent to and received 532 by the company 502. In some cases, rather than a time threshold for the application period, the recruiting system 504 or the company 502 may apply other types of thresholds, such as a predetermined number of users have submitted applications, a predetermined number of users with a position score above a minimum threshold, among others.

At time T7, the company 502 may hire 534 one of the candidates from the candidate list. The recruiting system 504 may receive the candidate selection or information related to the candidates hire. The system 504 may then determine the referral chain 536 associated with the hire. For example, if user 522 was hired by the company 502, the referral chain would include users 514 as the direct referral and user 508 as the originating referral.

Once the referral chain is determined or identified and at time T8, the recruiting system 504 may distribute funds 538 to the users on the referral chain. For instance, in the above example, the user 508 may receive funds 540 as the originating referral and the user 514 may receive funds 542 as the direct referral. Additionally, user 522 may also receive funds 544 as an applicant for the position. It should be understood, that the amount received by user 508 and 514 may vary, for example, based on the number of individuals in the referral chain, the value of the individual hired (e.g., salary or score/rank), the number of individuals receiving funds, etc. Candidates may subscribe for the earnings through interviews feature. Our internal team will verify the candidate's skills and qualifications before approving them for an interview. For each successful interview, our system will provide ratings to the candidates. Based on the ratings our system will provide interview bonus/incentives.

Users/Candidates may receive a hiring bonus if they are selected for a job within a certain period of time after registration. The bonus will be calculated based on a percentage of the salary that is offered to them.

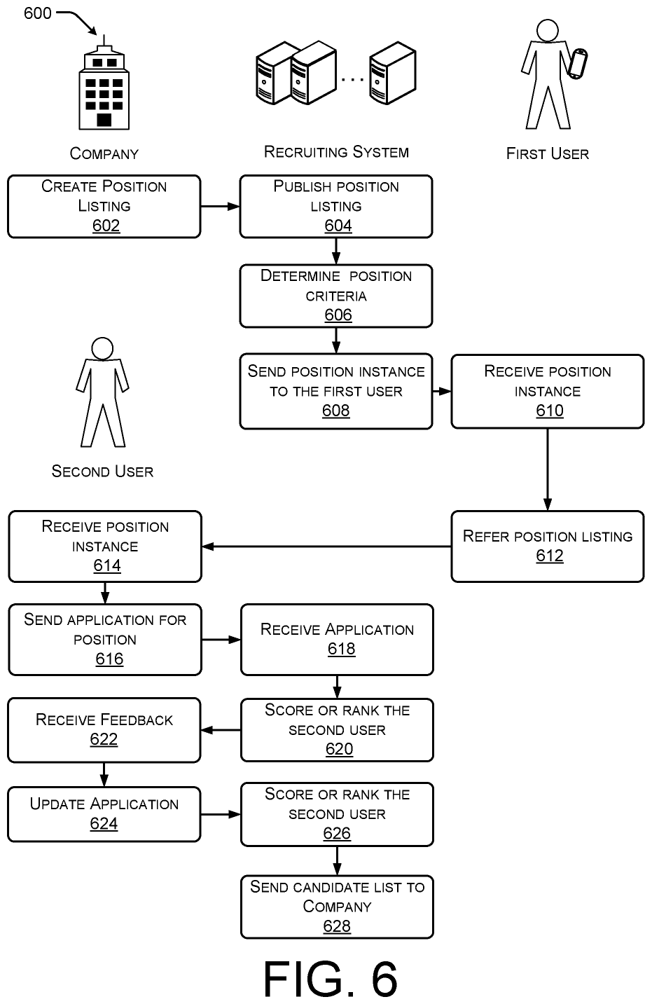

FIGS. 6-8 are flow diagrams illustrating example processes associated with the recruiting system discussed above. The processes are illustrated as a collection of blocks in a logical flow diagram, which represent a sequence of operations, some or all of which can be implemented in hardware, software or a combination thereof. In the context of software, the blocks represent computer-executable instructions stored on one or more computer-readable media that, which when executed by one or more processors, perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the process, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 6 is example flow diagram showing an illustrative process 600 for identifying a candidate list according to some implementations. For instance, as discussed above, recruiting system may be configured to allow individuals users to apply for positions created by a company. The recruiting system or platform may be configured to sort and/or filter users based on the details related to the position, user profiles, user submitted data, and/or third-party data about the users and/or company.

At 602, the company may generate or create a position listing. For example, the position listing may include the candidate requirements (e.g., job description, work history, special skills, industry knowledge, etc.), the application criteria (e.g., location, time frame, number of candidates, etc.), and any special requirements.

At 604, the recruiting system may publish the position listing to the user base. For example, the recruiting system may publish the listing to all users, a subset of users, or specific users of the system. For instance, the recruiting system may convert the candidate requirements, the application criteria, and the special requirements into a set of criteria that may be used to score or rank the users of the system with respect to a compatibility of fit for the position with the company as well as third party information determined about the company. For example, the recruiting system may access employee comments, company social media pages, company web site, customer reviews, etc. to determine additional information about the company for the creation of criteria to score the users.

At 606, the recruiting system may determine the position criteria. For example, the recruiting system may score individual users of the system using the data found on the user profiles, third party systems, or via recommendations.

At 608, the recruiting system may send a position instance or notification of the position to the first user. For example, the first user may be have received a high score or a score over a minimum threshold, such that the recruiting system provided an instance, invite, or notification of the position to the first user. Thus, at 610, the first user may receive position instance.

At 612, the first user may refer the position listing with a second user. In some cases, the first user may also apply for the position but, in others, the first user may determine that they do not wish to apply and, therefore, forward the position on. In this case, the recruiting system may record or initiate a referral chain, thereby creating a record that the first user invited the second user to apply for the position or that the first user determined the second user was a good candidate for the position.

At 614, the second user may send an application for the position. For example, the second user may apply via the recruiting system. In some cases, the application process may be relatively quick and easy for the second user when compared with conventional recruiting techniques. For example, the recruiting system discussed herein, may generate the application on behalf of the user based on the user's profile and other information known about the second user. Thus, the second user may not need to complete large amounts of paper work or create a resume that is typical with conventional techniques.

At 616, the second user may send an application for the position to the recruiting system. At 618, the recruiting system may receive the application from the second user.

At 620, the recruiting system may score or rank the second user based on the criteria determined at 606. For example, the recruiting system may re-apply the criteria determined at 606 to the second user. In some cases, the second user's score may be updated based on additional information determined about the second user, supplied by the second user, or identified with respect to third party information about the user.

At 622, the second user may receive feedback or a request for additional information from the recruiting system. For example, the recruiting system may provide the second user's score to the second user along with recommendations on how to improve the second user's score. In some cases, the recommendations may include low scoring areas (e.g., the second user lacks a particular skill, the second user failed to meet a particular criterion, such as work experience, the second user lacks a certification, or information about the second user is spares with respect to particular qualification) and suggestions on how to improve the score (e.g., submit additional information, add a section to the second user's profile, obtain a certification, etc.).

At 624, the second user may update the application. In some cases, the second user may submit an updated application, while in other cases, the second user may update the user profile, for instance, by adding a new skill, publication, volunteer activity, etc. which causes the recruiting system to update the application on behalf of the second user.

At 626, the recruiting system may again score or rank the second user based on the criteria determined at 606. For example, the recruiting system may re-apply the criteria determined at 606 to the second user. In some cases, the recruiting system may rescore each candidate upon a final close of the application process. In other cases, the second user may provide a trigger (such as reapplying) that causes the recruiting system to re-score the second user. In some specific examples, the recruiting system may for each score provide feedback to the second user. In this manner, the second user may continue to improve the application over a period of days, weeks, or even months.

In some examples, the recruiting system may also provide feedback following the completion of the application period. For instance, if the second user did not score highly enough (e.g., in the top predetermined number of application or above a predetermined threshold), the system may provide feedback relating why other candidates were selected for the candidate list (e.g., what items the second user's profile or application were lacking when compared with other candidates). In this manner, the second user may improve their score with respect to similar positions in the future.

At 628, the recurring system may generate and send a candidate list to the company. For example, the candidate list may include the highest scoring candidates with respect to the position criteria (e.g., a predetermined number of candidates). In other cases, the candidate list may include any number of candidates that scored above a threshold.

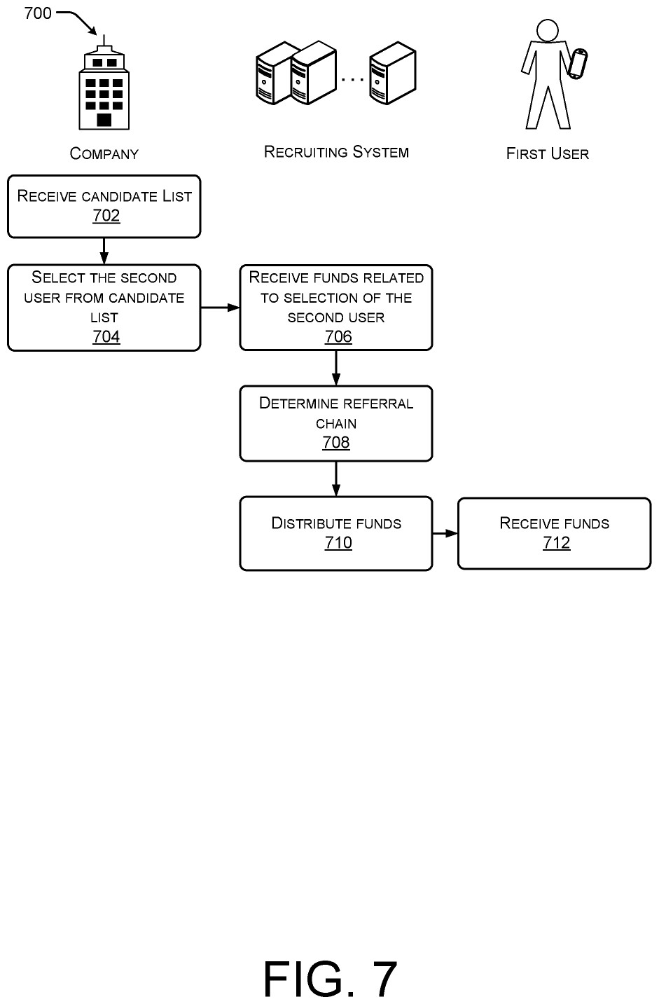

FIG. 7 is example flow diagram showing an illustrative process 700 for distributing funds associated with a referral chain according to some implementations. As discussed above with respect to FIG. 6, the process 600 included receiving a position listing from the company and, in response, providing the company with a candidate list to fill the position.

At 702, the company receives the candidate list from the recurring system. As discussed above, the candidate list may include the highest scoring candidates with respect to the position criteria (e.g., a predetermined number of candidates). In other cases, the candidate list may include any number of candidates that scored above a threshold.

At 704, the company may select the second user from the candidate list to fill the position. For example, the company may undertake interviews at various levels as well as additional screening techniques to select the second user.

At 706, the recruiting system may receive funds for successfully placing the candidate with the company. In other examples, the recruiting system may receive funds in response to sending the candidate list. For instance, the company may pay a fixed fee per number of candidates provided in the candidate list.

At 708, the recruiting system may determine referral chain associated with the individuals on the candidate list and/or with respect to the selected user (e.g., the second user).

At 710, the recruiting system may distribute funds to one or more of the users associated with the referral chain. For example, the recruiting system may distribute some amount to the referral chain originator, the directly refer (e.g., the user that referred the posting with a candidate on the candidate list or with the select candidate), each user on the referral chain, each individual on the referral chain (e.g., including non-system users that forward the position), a predetermined number of users within the referral chain proximate to the candidate, among others.

At 712, a user, such as in this example, the first user may receive the funds. For example, the funds may be deposited into an account on file with the recruiting system, transferred via a payment system, or stored within the recruiting system as part of the user profile.

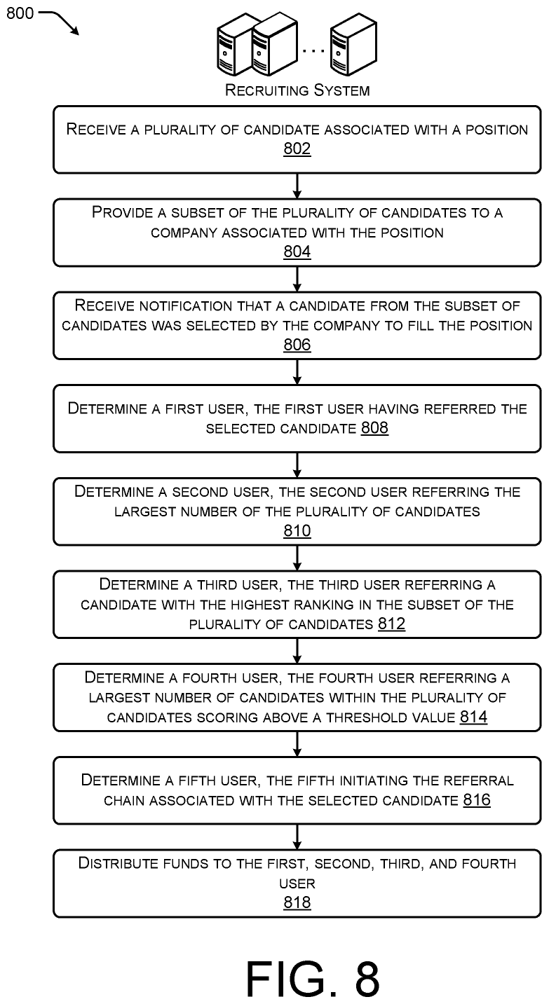

FIG. 8 is another example flow diagram showing an illustrative process 800 for distributing funds associated with a referral chain according to some implementations. As discussed above, the recruiting system may be configured to generate a candidate list from a plurality of candidates and to distribute funds received in response to placing a candidate or providing the candidate list to a company to users of the system.

At 802, the recruiting system may receive a plurality of candidates associated with a position. For example, a plurality of users of the system may apply as candidates to fill a position.

At 804, the recruiting system may provide a subset of the plurality of candidate to the company associated with the position. For example, the recruiting system may rank the candidates based on scoring criteria determined from the position information provided by the company. In some cases, the subset may include the highest scoring candidate's or candidates that scored above a threshold.

At 806, the recruiting system may receive notification that a candidate from the subset of candidate was selected by the company to fill the position. For example, the recruiting system may identify that the candidate has a new position or receive feedback from company that the search is complete.

At 808, the recruiting system may determine a first user form the referral chain of the position. In this example, the first user may have recommended the selected candidate to apply to the position.

At 810, the recruiting system may determine a second user form the referral chain of the position. In this example, the second user may have recommended the largest number of the plurality of candidates. In another example, the second user may recommend the largest number of candidates of the subset of candidates.

At 812, the recruiting system may determine a third user form the referral chain of the position. In this example, the third user may have recommended the candidate with the highest score or ranking.

At 814, the recruiting system may determine a fourth user form the referral chain of the position. In this example, the fourth user may have recommended the largest number of candidates scoring over a threshold.

At 816, the recruiting system may determine a fifth user form the referral chain of the position. In this example, the fifth user may have invented the referral chain.

At 818, the recruiting system may distribute funds to the first user, the second user, the third, user, the fourth user, and the fifth user. For example, the funds provided to each user may vary based on various factors.

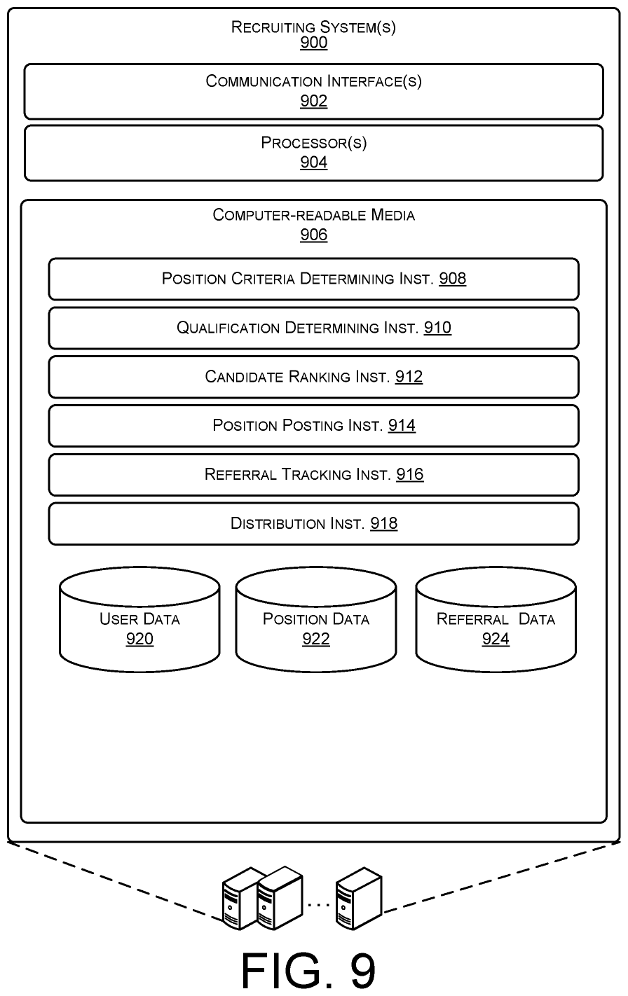

FIG. 9 illustrates example components of one or more servers associated with the recruiting system 900 according to some implementations. The servers, which host the recruiting system 900 collectively comprise processing resources, as represented by communication interfaces 902, processors 904, and computer-readable storage media 906.

The communication interfaces 902, which may support both wired and wireless connection to various networks, such as cellular networks, radio (e.g., radio-frequency identification RFID), WiFi networks, short-range or near-field networks (e.g., Bluetooth®), infrared signals, local area networks, wide area networks, the Internet, and so forth. For example, the communication interfaces 902 may allow the recruiting system 900 to identify candidates, as well as to communicate with one or more third party systems, such as social media systems and/or company systems.

The computer-readable storage media 906 may include volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device.

Several modules such as instruction, data stores, and so forth may be stored within the computer-readable media 906 and configured to execute on the processors 904. For example, position criteria determining instructions 908, qualification determining instructions 910, candidate ranking instructions 912, position posting instructions 914, referral tracking instructions 916, distribution instructions 918, cultural fit instructions 926, and/or personality instructions 928. The computer-readable media 906 may also store data usable by the processor 904 in executing the instructions. For example, the computer-readable media 906 may store user data 920, position data 922, and/or referral data 924. The user data 920 may include various information known about each user of the system 900. The position data 922 may related to the various open position with the recruiting system 900, and the referral data 924 may include data to track and maintain referral chains.

The position criteria determining instructions 908 may be configured to receive a position, job description, or position data and to covert the received data into one or more criteria that can be used to score or rank individual candidates.

The qualification determining instructions 910 may be configured to identify one or more users of the recruiting system that may be a good candidate to fill the position with the company. For example, the system may utilize the criteria identified by the position criteria determining instructions 908 to score one or more of the users of the system based on, for instance, the user's profile data. In some cases, the system may invite users scoring above a threshold to apply for the position.

The candidate ranking instructions 912 may determine a ranking of the candidates that applied to fill the position. For example, the candidate ranking instructions 912 may score each candidate using the criteria at one time, such that any edits or addition to the user profile, application, etc. that a candidate made are taken into consideration in the final ranking. The candidate ranking instructions 912 may then send a list of the top predetermined number of candidates to the company.

The position posting instructions 914 may be configured to post the position information to various locations at which a potential candidate may access. In some cases, the position posting instructions 914 may also send invites to apply for the position to select users of the system that scored above a threshold amount, generally make good referrals, and/or have referred individuals placed for similar positions.

The referral tracking instructions 916 may be configured to track referrals of the position between users and individuals. For example, the referral tracking instructions 916 may generate a referral chain for each instance of the position that is referred between individuals or users of the system.

The distribution instructions 918 may be configured to distribute funds to users associated with the referral chain generated by the referral tracking instructions 916. For example, the distribution instructions 918 may distribute funds to the referral chain initiator, the individual that referred the largest number of candidates, the individual that directly referred a candidate or hire, etc.

The cultural fit instructions 926 may be configured to survey a candidate or user to collect cultural information related to the individual. For example, the candidate or user may complete a survey that asks the user to rate how important or unimportant various factors are to them in a work environment. For instance, the factors may include one or more of work ethic, atmosphere, creative problem solving or solutions, social responsibility, freedom of expression or self-expression, team work, individual or team recognition, support network, among others. In some cases, the cultural fit instructions 926 may also request references of the candidate to complete the same survey, a subset of the survey or a alighting different questionnaire related to the same or similar factors on behalf of the candidate. The cultural fit instructions 926 may then determine a cultural fit for the candidate.

In some cases, the cultural fit instructions 926 may also cause questioners to go out to employees at various companies that have positions posted at the system 900. The cultural fit instructions 926 may aggregate and process the employee answers to determine an actual cultural of company. Thus, unlike conventional systems, the recruiting system discussed herein determines the cultural of the companies based on aggregated employee data opposed to the traditional method of receiving the cultural fit from the executive or management level team. In some cases, the cultural fit instructions 926 may also survey individuals who work in the same position, job, industry, geographical area, such that the system 900 is able to determine if a company's culture differs from or complies with other industry competitors and/or to determine if the company's culture changes over georgical or position basis. In some cases, the cultural fit instructions 926 may make recommendations to a company to change or update cultural goals, rules, or tenants based on success of competitors with different cultural values whom are also having more success in hiring. For instance, the cultural fit instructions 926 may recommend a flexible work hour program to a company who is having difficultly recruiting in a city compared with competitors who already offer a flexible work hour program.

In regard to a particular position posting, the system 900 may be configured to match, refer, and recommend candidates to apply to the position and for hiring to fill the position based on determining a match (such as greater than a threshold match level) between the cultural fit of the candidate and the cultural of the hiring company. in this manner, the company may be more successful in retaining hired employees as they are more likely to fit into the culture of the company and thus have an easier transition period.

The personality instructions 928 may be configured to determine a DISC assessment, OCEAN assessment, and/or a per position personality match score for each candidate of each position listing. Thus, in addition to providing the DISC and/or OCEAN assessment, the company or hiring manager may also have the per position personality match score that may allow the hiring manager to achieve higher retention rates post hiring as the selected candidate is more likely to match the personality of the company and/or the particular position/office they are assigned.

In some examples, the personality instructions 928 may survey each of the potential candidates using one or more personality test, such as DISC or OCEAN assessments. The personality instructions 928 may also receive the user and/or third-party inputs and/or cultural fit results from the cultural fit instructions 926 as well as to receive personality questions from third parties, such as the candidates selected referrals or system 900 identified referral/network connections. In this way, the system 900 receives each candidate's self-personality evaluation as well as cultural data and third-party personality data. The personality instructions 928 may then process the data and generate a personality profile (that includes the DISC or OCEAN assessment but it's also personalized to each candidate using the additional data collected by the system). In some cases, the cultural fit instructions 926 may generate the per position personality match score based on each position listing for each company. For example, the personality instructions 928 may determine personality fits for each position based at least in part on the position data (position requirements, rewards, type, industry, seniority, etc.), similar listing data (e.g., candidate selected for similar positions, candidates selected to interview for similar position, retention rate on similar position after hire, etc.), company preferences (e.g., personality that company is looking for), among others. The per position personality match score may then be used to recommend candidates to companies and/or position listing to candidates. In some cases, the company may receive the per position personality match score for each candidate that applied to a position listing.

In one particular example, the personality instructions 928 may receive an input from or suggest to a user that the user completes a personality test. The user may then select or complete one or more of a personality test (e.g., DISC or OCEAN) and/or cultural test. The user may then be asked to rate themselves based on one or more traits (such as inventiveness, approach to problem solving, resourcefulness, sensitive towards others, openness, passion, faith in others, apprehensiveness related to self or others actions, literal v. subjections, effectiveness in influencing outcomes, friendliness, socialness, temperament, apathy, desire to follow the rules, activity level, independentness, self awareness, attention to detail, ability to conform, discipline, self-assuredness, spontaneity, among others. The user may also be asked to rate themselves based on cultural aspects such as work ethic, creativeness, social responsibility, freedom or self-expression, team achievement, value of support network, flexibility, innovation, collaboration, optimism, etc. The personality instructions 928 may then present the results of the per position personality test and/or cultural fit to the user. In some cases, the personality instructions 928 may also recommend positions that would be a good fit for the user based on the user's skill set and the user's personality or cultural scores.

In some implementations, the personality instructions 928 may also reach out to connections of the user either on the user's request or behalf. The personality instructions 928 may then ask third-party individuals to rate the user based on the traits listed above. The personality instructions 928 may update the per position personality test results upon each additional third-party rating the user. The personality instructions 928 may also utilize data such as the user's resume, profile, interview results, video data, or transcripts, third-party feedback, etc. to assist with improving the user's per position personality test. Also, it should be understood, that the user's per position personality test may vary based on the details of the particular position listing the user is applying for. for example, different companies may value different traits differently, different industries may value different traits differently, and different types of positions may be better suited for particular traits.

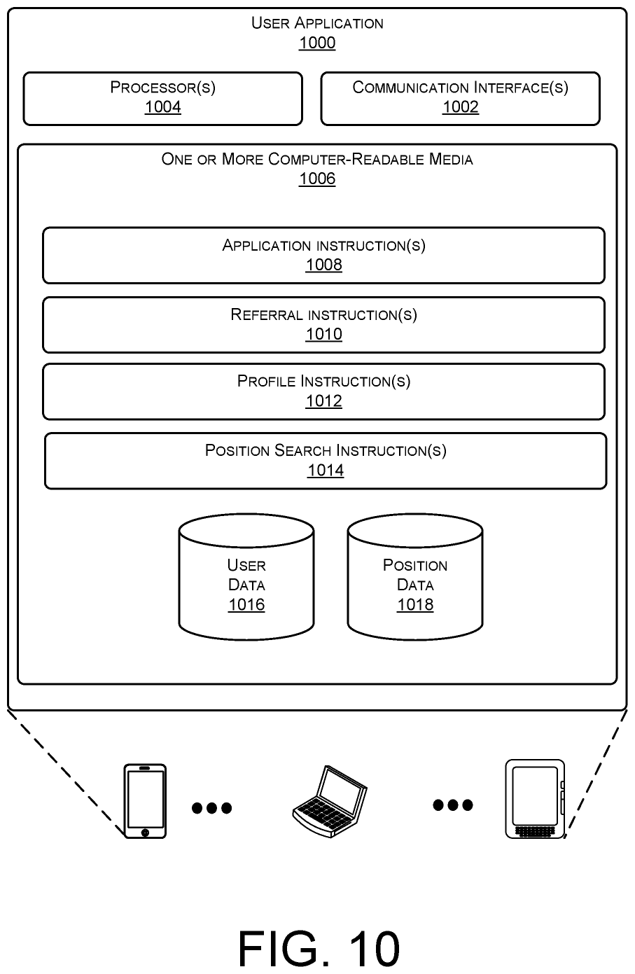

FIG. 10 illustrates example components of a device hosting a user or client-side application 1000 associated with the recruiting system according to some implementations. In some cases, individuals may have a client-side application or online interface/portal that allows the users to access the recruiting system.

The communication interfaces 1002, which may support both wired and wireless connection to various networks, such as cellular networks, radio (e.g., radio-frequency identification RFID), WiFi networks, short-range or near-field networks (e.g., Bluetooth®), infrared signals, local area networks, wide area networks, the Internet, and so forth. For example, the communication interfaces 1002 may allow the users to upload data to the recruiting system.

The computer-readable storage media 1006 may include volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device.

Several modules such as instruction, data stores, and so forth may be stored within the computer-readable media 1006 and configured to execute on the processors 1004. For example, the computer-readable media 1006 may store application instructions 1008, referral instructions 1010, profile instructions 1012, and/or position search instructions 1014. The computer-readable media 1006 may also store data usable by the processor 1004 in executing the instructions. For example, the computer-readable media 1006 may store user data 1016 and/or downloaded position data 1018.

The application instruction 1008 may allow a user of the system to apply as a candidate to the recruiting system for an open position. The referral instructions 1010 may allow the user to referral another user or individual to apply for a specific position. For example, the user may referral other users via the recruiting system and non-users via other social media or email. The profile instructions 1012 may allow the user to edit, update, or create a user profile with the system that may include qualification, job application, and resume related information. The position search instructions 1014 may allow the user to search for open position that may be a good fit for the user.

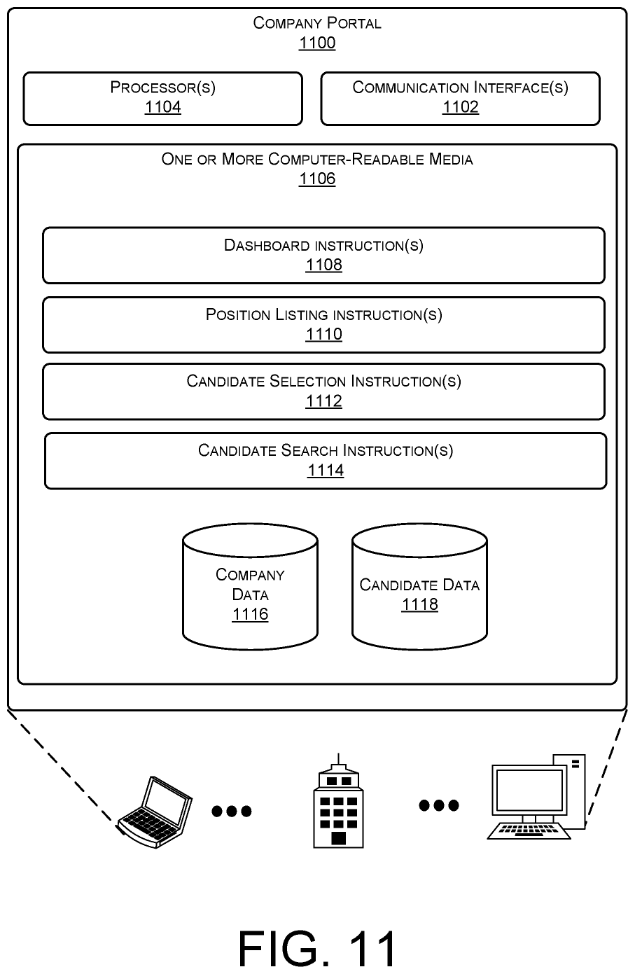

FIG. 11 illustrates example components of one or more servers associated with the company system hosting a portal 1100 associated with the recruiting system according to some implementations. For example, the companies or a human resource representative may have access to a company portal via the recruiting system to post open positions, evaluate metrics, and review candidates.

The communication interfaces 1102, which may support both wired and wireless connection to various networks, such as cellular networks, radio (e.g., radio-frequency identification RFID), WiFi networks, short-range or near-field networks (e.g., Bluetooth®), infrared signals, local area networks, wide area networks, the Internet, and so forth. For example, the communication interfaces 1102 may allow the human resource representative to upload position data to the recruiting system.

The computer-readable storage media 1106 may include volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device.

Several modules such as instruction, data stores, and so forth may be stored within the computer-readable media 1106 and configured to execute on the processors 1104. For example, the computer-readable media 1106 may store dashboard instructions 1108, position listing instructions 1110, candidate selection instructions 1112, and/or candidate search instructions 1114. The computer-readable media 1106 may also store company data 1116 and candidate data 1118.

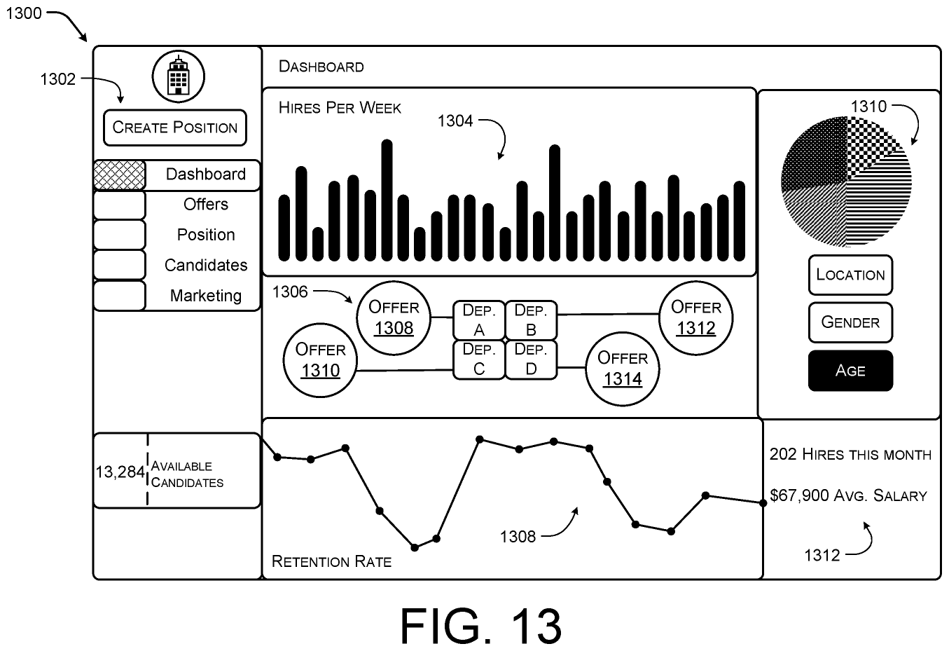

The dashboard instructions 1108 may allow the company or the human resource representative to review hiring and position listing data as well as to analyze success metrics associated with the recruiting system. For instance, FIG. 13 provide example dashboards that may be generated using the dashboard instructions 1108. For instance, the dashboards may include tips and information about trends based on real time data being collected, applicant data, system user data, historical data, etc.

The position listing instruction 1110 may allow the company or the human resource representative to upload new open position to the recruiting system. In some case, the position listing instruction 1110 may also allow the company or the human resource representative to update or modify existing position listing with the recruiting system. For example, if each candidate on a candidate list for a particular position is lacking a key qualification, the company may update the position listing to focus the recruiting system on identifying candidates with the key qualification or ranking the candidates with the key qualification above other candidates.

The candidate selection instruction 1112 may allow the company or the human resource representative to select one or more candidate to fill a position from the candidate list provided by the recruiting system. In some cases, the candidate selection instruction 1112 may allow the company or the human resource representative may also review candidate data 1118 related to the candidates within a candidate list prior to selecting a candidate.

The candidate search instructions 1114 may allow the company or the human resource representative to view or search for candidate using the recruiting system.

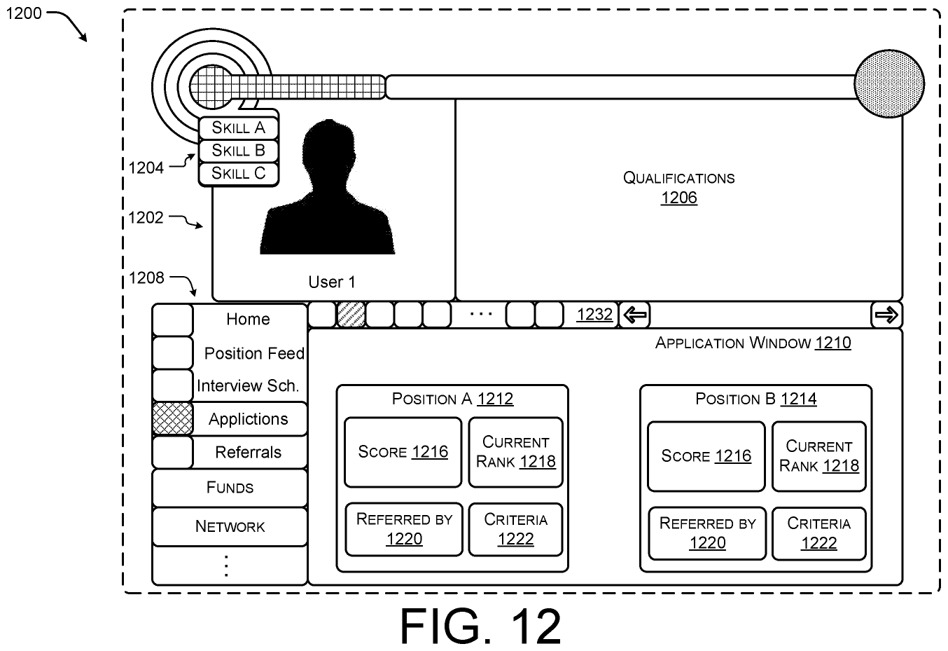

FIG. 12 illustrates an example user profile 1200 according to some implementations. The user profile 1200 may include various area such as user image 1202, skills 1204, and qualification 1206 (e.g., information about the user such as employment history, certifications, awards, patents, publications, etc.).

The user profile 1200 may also include a navigation menu 1208 to allow the user to view different information related to the user profile 1200. For example, the applications window 1210 is selected. In this example, the user has applied for two positions, positions A 1212 and position B 1214. Each of the positions 1212 and 1214 may provide the user with information, such as score 1216 (e.g., an assessment of the user's fit with respect to the position), current rank 1218 (e.g., how the user companies with other candidates for the position), the individual that referred the position 1220, and the criteria 1222 (e.g., the position requirements).

In some cases, the user profile 1200 may also include a position feed (e.g., window showing positions recommended or referred to the user), interview schedule, referrals (e.g., individuals referred by the user and positions referred to the user), funds (e.g., money received in response to a referral), and/or networks.

FIG. 13 illustrates an example company portal 1300 according to some implementations. In the current example, the company may utilize the dashboard to create a position 1302, view hires over time 1304, view current offer information 1306, monitor retention rate 1308, view demographic information related to hires 1310, and to view monthly metrics 1312. In some cases, the company may update positions, marketing information, review candidates, view or search a candidate pool, and make offers via the portal 1300.

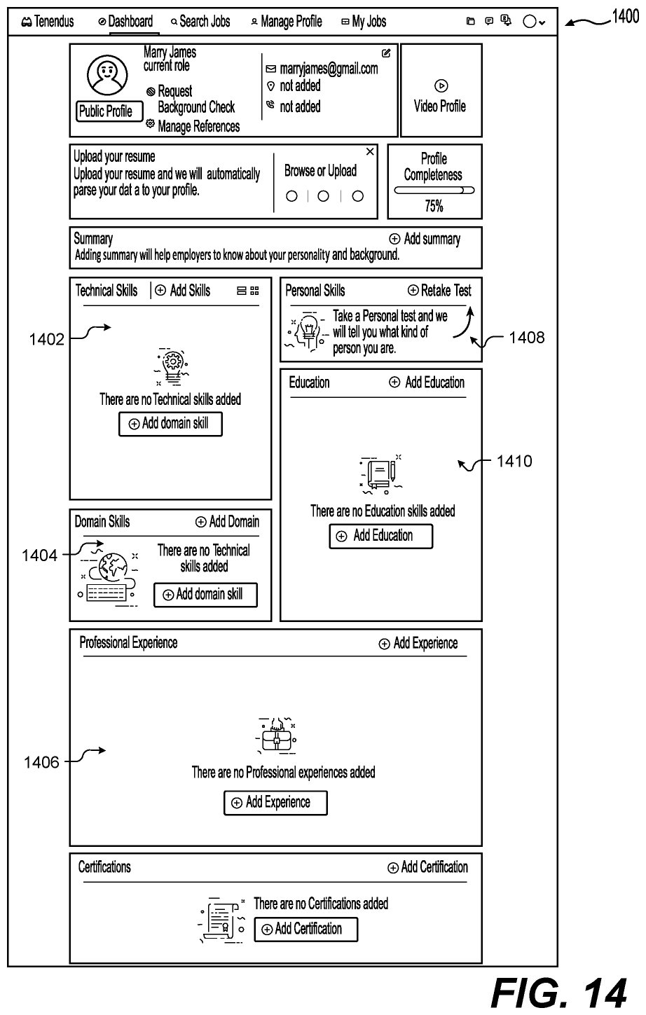

FIG. 14 illustrates an example view 1400 of a user portal according to some implementations. In the current example, the user may have a public profile and a private profile. In this case, the user may generate a profile by uploading a resume. If the user does upload the resume, the system may extract data from the resume to complete the user profile on the user's behalf. In some cases, the user may also enter technical skills, a summary, a free from description, personal skills, education, domain experience (e.g., history in an area of expertise), professional experience, work history, and certification or awards. The user may also upload video profile shareable to those on the system. In some cases, the user may also upload a list of special accomplishments such as articles, publications, awards, major projects, etc. In the current example, the view 1400 of the user portal may include separate areas for technical skills 1402, domain skills 1404, professional experience 1406, personal skills 1408, and education 1410.

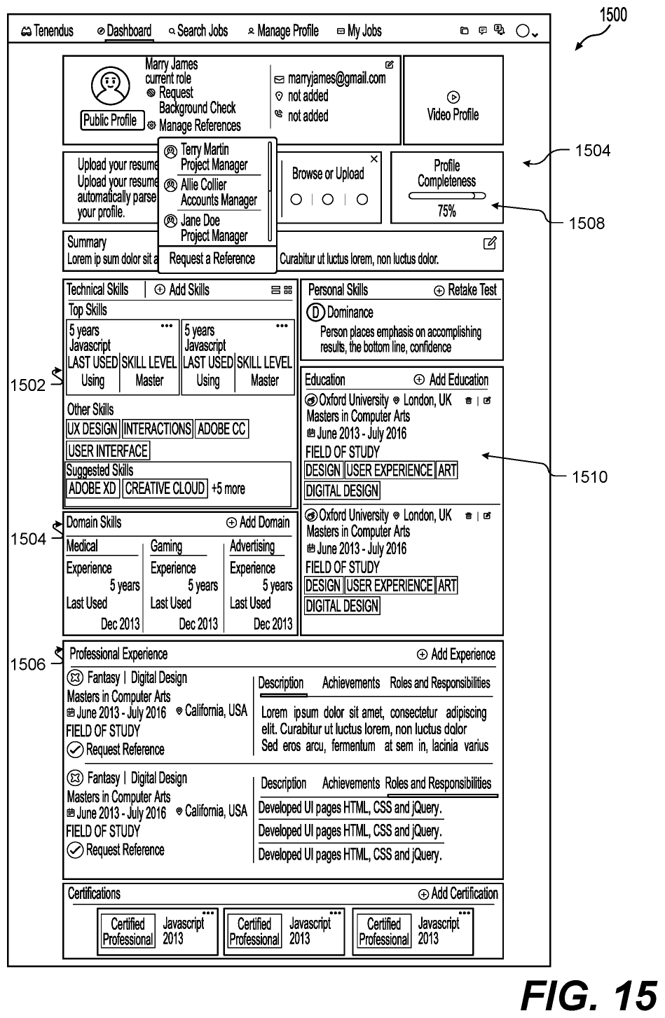

FIG. 15 illustrates an example reference request view 1500 of a user portal according to some implementations. In the current example, the user has completed their user profile via view 1400 of FIG. 14. The user may in addition to providing information and skills request references from other users of the system. For instance, in the current example, the user may be selecting from connected user to request a reference, generally indicated by 1502. In some cases, the reference will include a rating based at least in part on the individual making the reference.

Additionally, it should be understood, that in the current view 1500, the user's profile 1504 is shown behind the request a reference interface 1502. In this example, the system or platform may have parsed the documents provided or uploaded from the user via view 1400 of FIG. 14 or the user may have entered the profile information shown. For instance, the user's profile 1502 may include separate areas for technical skills 1502, domain skills 1504, professional experience 1506, personal skills 1508, and education 1510.

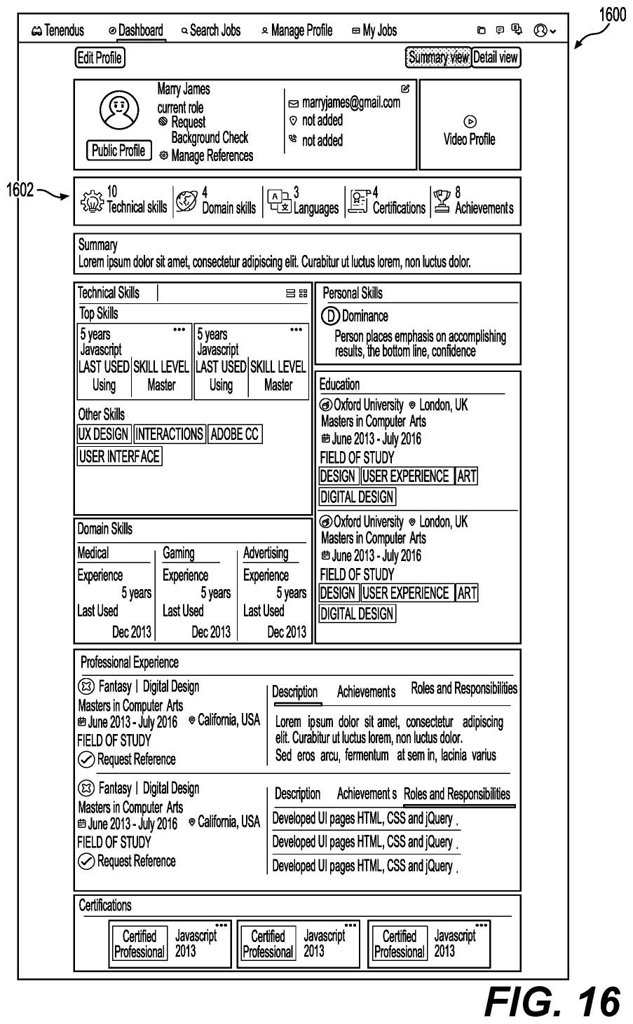

FIG. 16 illustrates an example detailed view 1600 of a user portal according to some implementations. In the current example, the user profile may provide a detailed view of the information of the user portal of FIG. 15. In this example, the system may provide quick indicators, generally indicated by 1602. In some cases, the quick indicators 1602 or the more detailed skills (not shown) may include rankings, rating, or experience indicators that a customer may use to evaluate the user for selection for an interview. For example, the quick indicators 1602 may be directed to items that are commonly important to hiring managers, recruiters, or companies in making hiring decisions. For instance, in the illustrated example, the quick indicators 1602 may include technical skills (for technical positions), domain skills, languages, certifications, achievements, verifications, etc. In some cases, the recruiting system or platform my select what type of quick indictors 1602 to display based on the identity of the person or entity viewing the profile. For example, the system may include technical skills and certifications for technical positions and languages or years' experience for more marketing or sales related positions. In some cases, the system may include voice enabled profiles, profiles with audio files, profiles with video files, or profiles that may be updated using voice or image inputs. Further, it should be understood that some types of quick indictors 1602, such as technical skills and domain skills, may vary based on the field and type of position the candidate is searching for or the company, hiring manager, or recruiter is looking for.

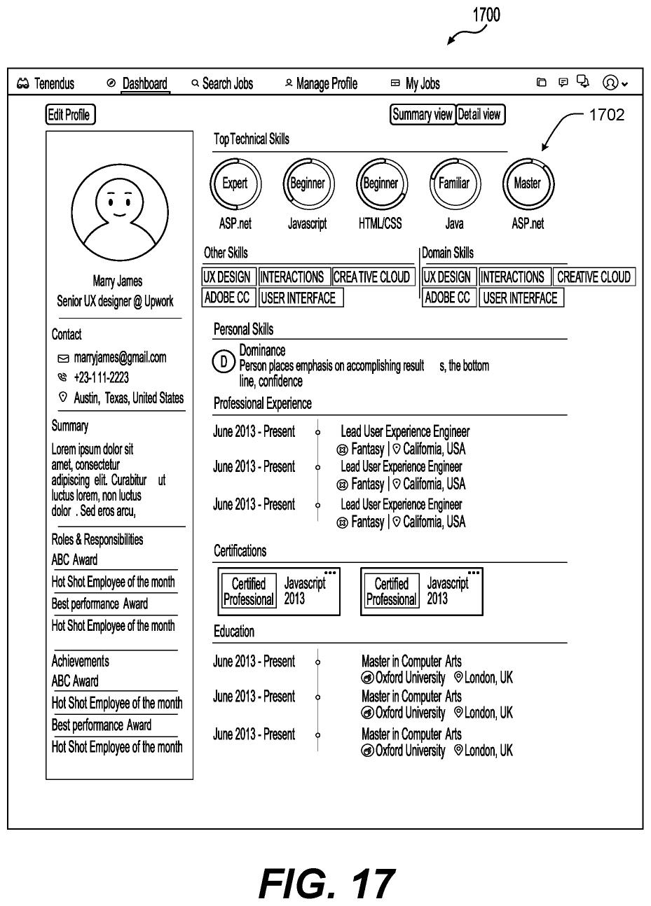

FIG. 17 illustrates an example summary view 1700 of a user portal according to some implementations. In the current example, a summary of the user's skills and information associated with the profile may be displayed, such as for companies to quickly identify potential candidates for an open position. In some examples, the user or the recruiting system itself may share a profile or the summary view 1700 with other user in the system. In some cases, the system may, on the user's behalf or in response to a selection by the user, may select highlights, generally indicated as 1702, for each of the quick indictors and illustrate them as part of the view 1700. For example, the current example shows top technical skills, other skills, domain skills, personal skills, DSIC assessment, and experience as part of the summary view 1700.

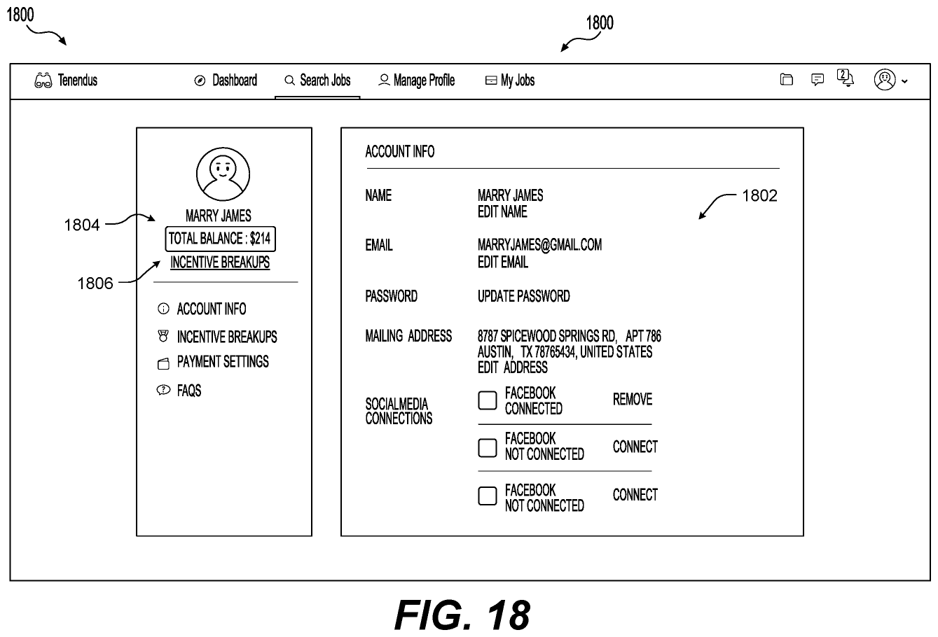

FIG. 18 illustrates an example account information view 1800 of a user portal according to some implementations. In the current example, the user may view account information 1802 as well as information relating to a total balance 1804. In this case, the balance 1804 may be received for referring candidate to positions, for having referred candidates selected for a position, for applying to positions, for being selected as a candidate for a position by the system, for being selected as a candidate for a position by the end customer or company positing the position, among others. Further, the user may view the details as to how the incentive balance 1804 was earned by selecting the incentive breakups selection option 1806.

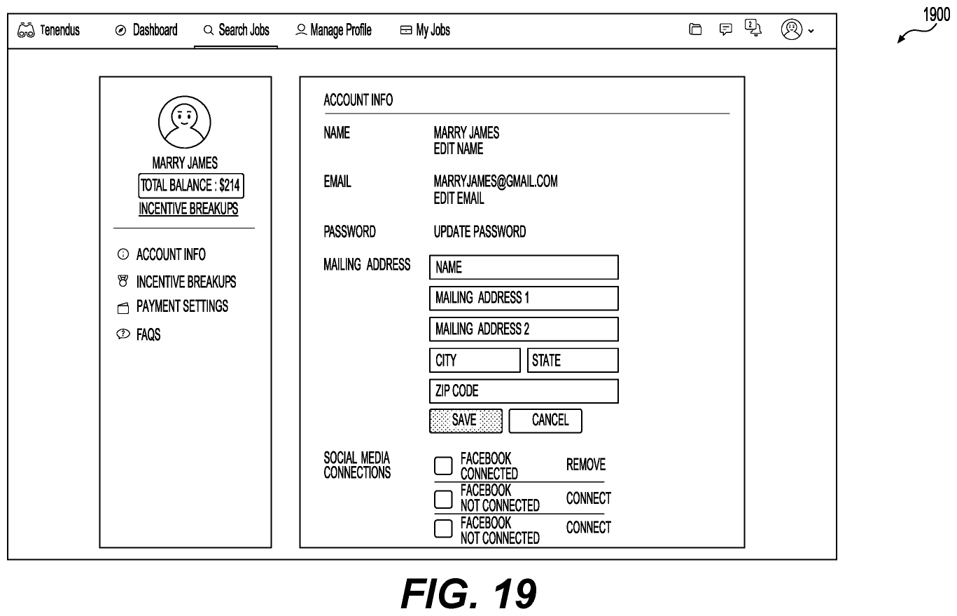

FIG. 19 illustrates another example account information view 1900 of a user portal according to some implementations. In this example, the user may update account information, such as address and social media accounts. In some cases, the system may use the updated data to recommend or search for positions on behalf of the user.

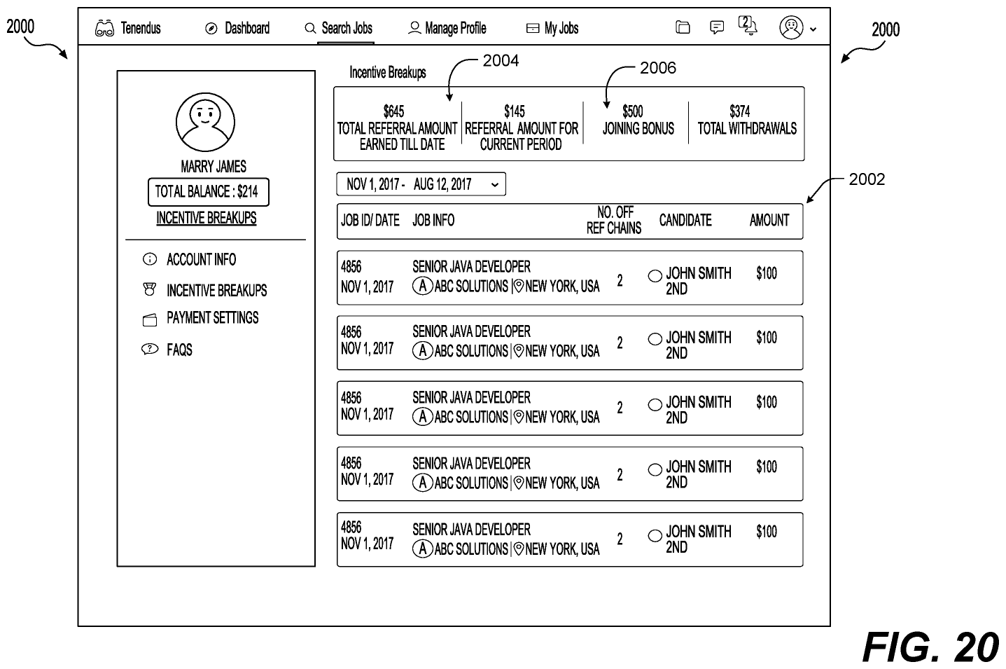

FIG. 20 illustrates an example position search view 2000 of a user portal according to some implementations. In the current view, the user may search for positions or jobs based on various criteria, generally indicated by 2002, as well as view the reward or referral fee, generally indicated by 2004, for recommending candidates to each position. In the current example, the user may also earn joining bonuses 2006 from the platform when the user takes a position with a company. For example, the user may search parameters based on geographic location or proximity, consumer index, schools or educational rating, crime rate or safety ratings, new or events (such as annual festivals).

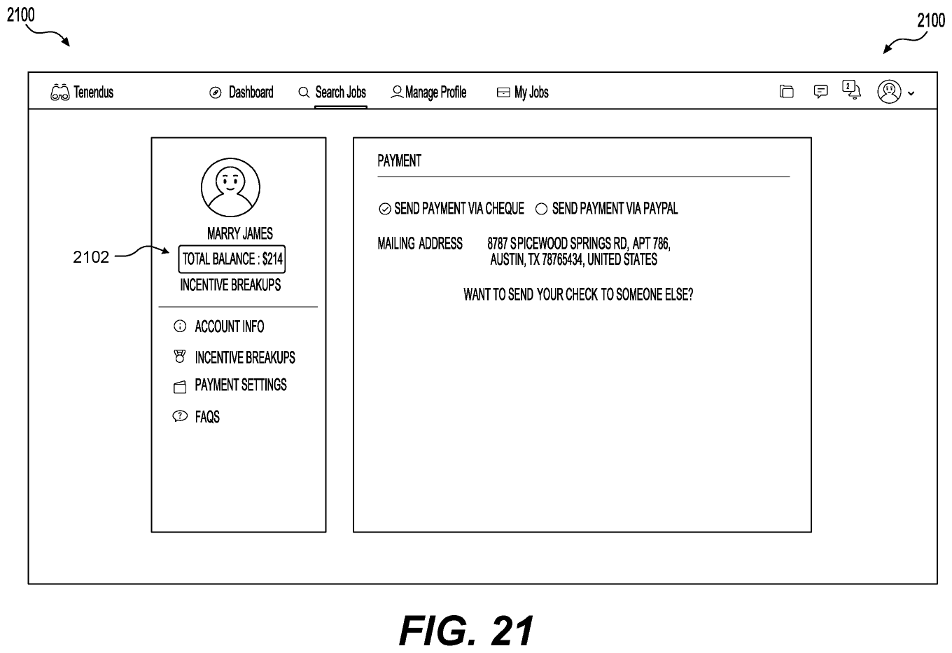

FIG. 21 illustrates an example incentive payment view 2100 of a user portal according to some implementations. In the current view the user may cause the balance 2102 to be distributed to various accounts, such as electronic banking accounts and electronic payment accounts. In some cases, the transfers may be tracked or monitored via technology, such as block chain.

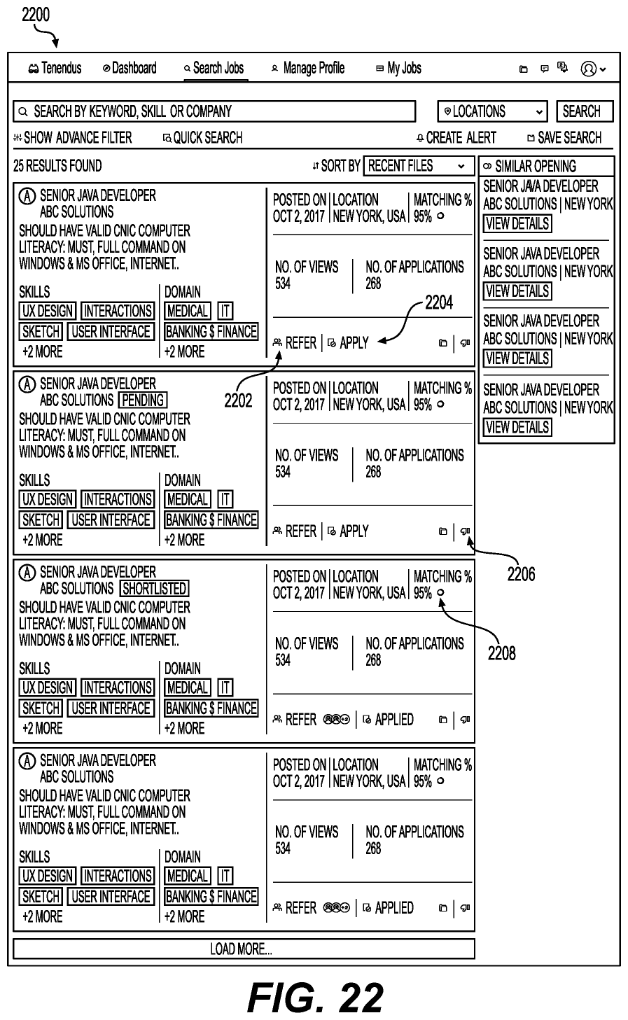

FIG. 22 illustrates an example position application view 2200 of a user portal according to some implementations. For instance, in the current example, a user may search for or the system may select on behalf of the user and recommend to the user, based on user's skill set and known information about the position, positions to the user. The user may then apply to the positions 2202 or refer a candidate for the positions 2204 based on the implementations which also include voice enabled features. By referring 2202 a candidate to a position, the user, as discussed above, may earn a referral fee.

The user may also rate a position 2206. For example, the user may rate the position based on past working experience at the company, based on experience during an interview the user had with the company, or other information known about the company. The rating 2206 may be aggregated by the system and presented to user's considering applying to help users decide if they should apply for the open position. In some cases, the rating 2206 may be applied to the company as an overall rating related to the work experience or interview experience of individuals having knowledge. In one specific example, the rating 2006 may be used by the platform to assist in recommending a position (e.g., companies with higher rated ratings may be recommend to more candidates than companies with lower rated ratings). Additionally, the rankings 2006 may be used by the system to generate suggestions to the company or hiring manager that may be used to improve the success rate of a particular position posting. For example, if candidates regularly rate the position listing poorly, the system may compare the position listing to other listings determined to be similar but achieving a higher rating. The system may then determine differences between the two position listings and make suggestions based on the determined differences.

In the current example, the system may also analyze a user's compatibility or matching score 2208 with respect to the position. For instance, the system may compare the company needs associated with the position with the user's skills and experience to determine a score. Thus, the system may help the users apply for positions in which they are likely to be selected as a candidate. In some examples, the user's score 2208 may change in substantially real-time as the user updates their profile. In some specific cases, the system may make recommendations to the user as to how to improve their score 2208 with respect to a desired position.

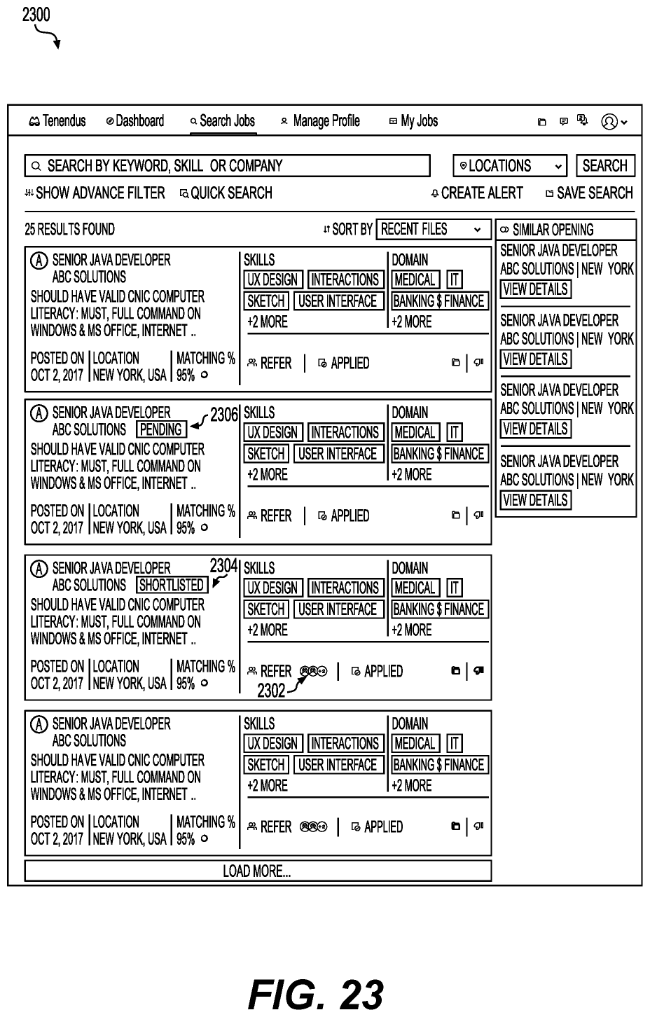

FIG. 23 illustrates another example position application view of a user portal according to some implementations. The view 2300 show an alternative layout of the view 2200 discussed above with respect to FIG. 22. In the current example, the system may suggest friends 2302 of the user that may be good candidates according to the system to refer for a position. The system may also suggest position or jobs that the candidate should consider applying for. In some cases, the suggested positions may be based on date or by matching percentage. The system applies a technique designed to calculate the matching percentage of applicant to job. In some examples, the suggestions may be provided via alerts or as changes in a position occur new alerts may be generated to keep the user informed.

The system may also provide the user with information related to the status of applied for positions. For instance, in this example, the user has been shortlisted 2204 (e.g., selected as a candidate) for one position and her application for a second position is pending 2206. Other status indicators may include declined to interview, rejected, removed from consideration, interview granted, interview scheduled, among others.

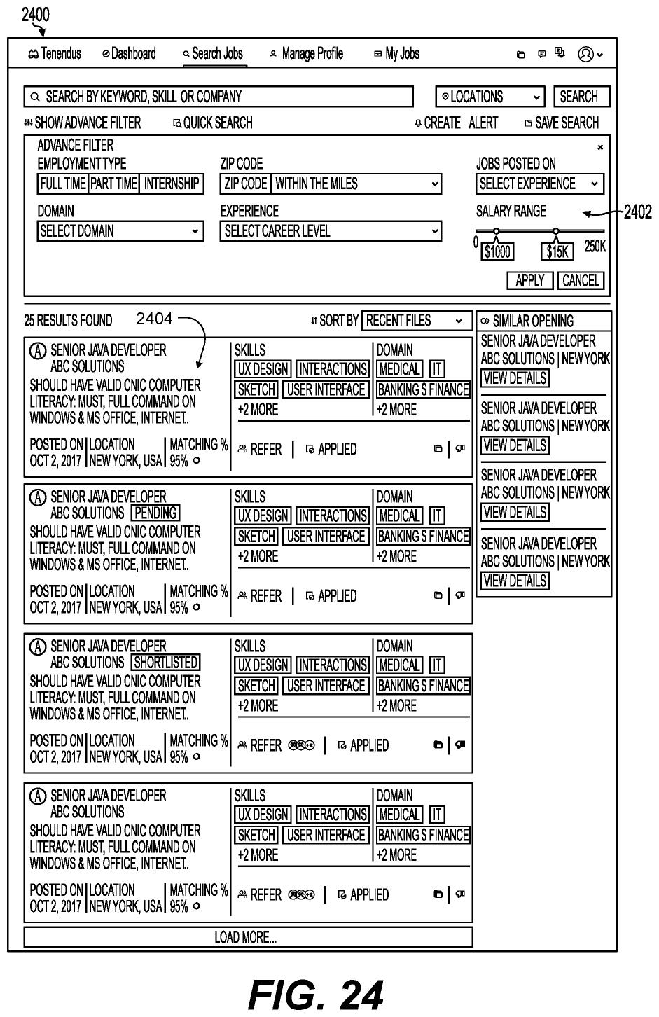

FIG. 24 illustrates yet another example position application view 2400 of a user portal according to some implementations. In the current example, the user may customize a search using various criteria, generally indicated by 2402. For instance, the criteria 2402 may include location boundaries, dates, salary range, experience or domain skill requirements, status (such as part time or full time), size of company, etc. In the current example, the results 2404 may populate based on best available matches below the criteria selection area 2402.

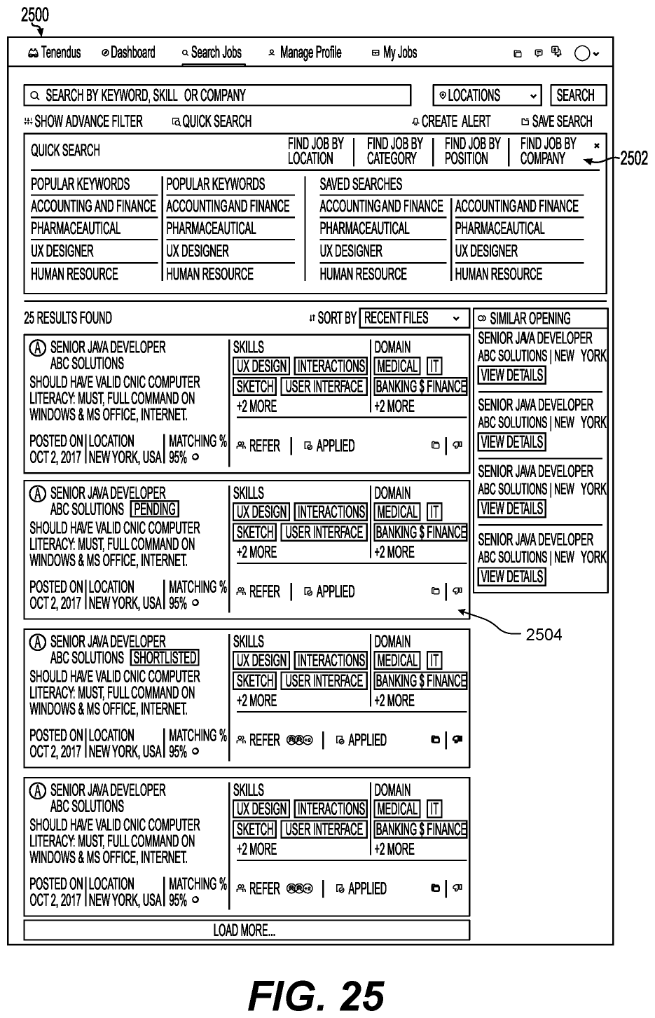

FIG. 25 illustrates yet another example position application view 2500 of a user portal according to some implementations. In the current example, the user may use some quick search criteria 2502 suggested by the system. For instance, the system may select the quick search criteria 2502 based on information known about the user, such as profile information, past searches, past employment, past interviews, etc. In the current example, the results 2504 may populate based on best available matches below the quick search criteria area 2502.

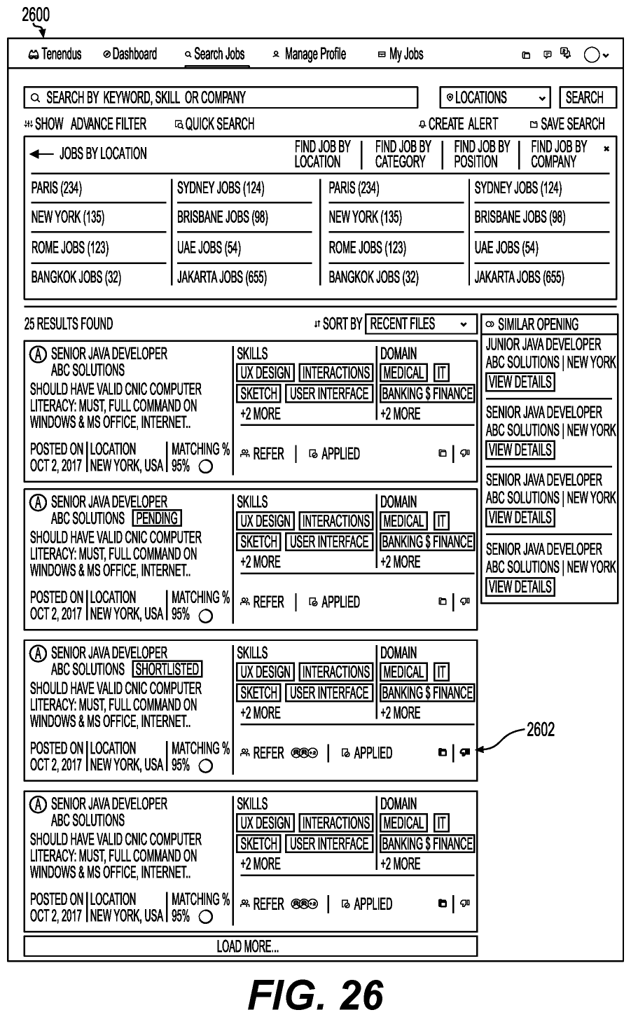

FIG. 26 illustrates yet another example position application view 2600 of a user portal according to some implementations. As discussed above, the user may rate a position 2602. For example, the user may rate the position based on past working experience at the company, based on experience during an interview the user had with the company, or other information known about the company. The rating 2602 may be aggregated by the system and presented to user's considering applying to help users decide if they should apply for the open position. In some cases, the rating 2602 may be applied to the company as an overall rating related to the work experience or interview experience of individuals having knowledge

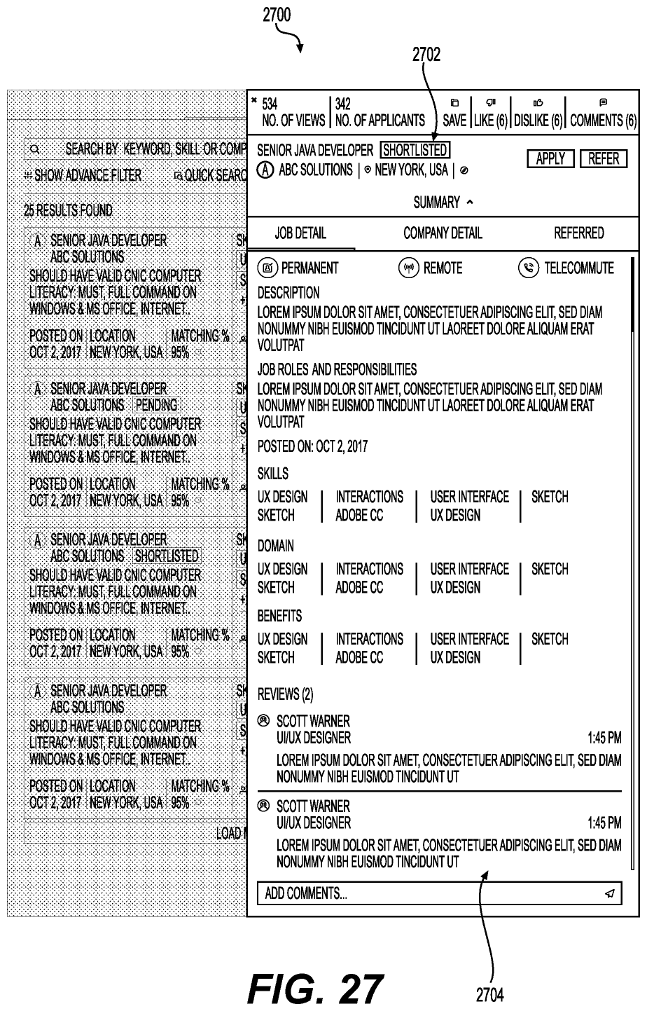

FIG. 27 illustrates an example detailed view 2700 of a position posting according to some implementations. In the current example, the details related to the viewed posting 2700 are presented to the user. The user can see their status 2702 and read reviews 2704 of others whom have interview with the company for the particular position. In some cases, the reviews 2704 may be used to assist the user in making a decision on whether or not to apply to the position. In some cases, the system may utilize the reviews as an input to the position listings rating or in recommending the position to potential candidates.

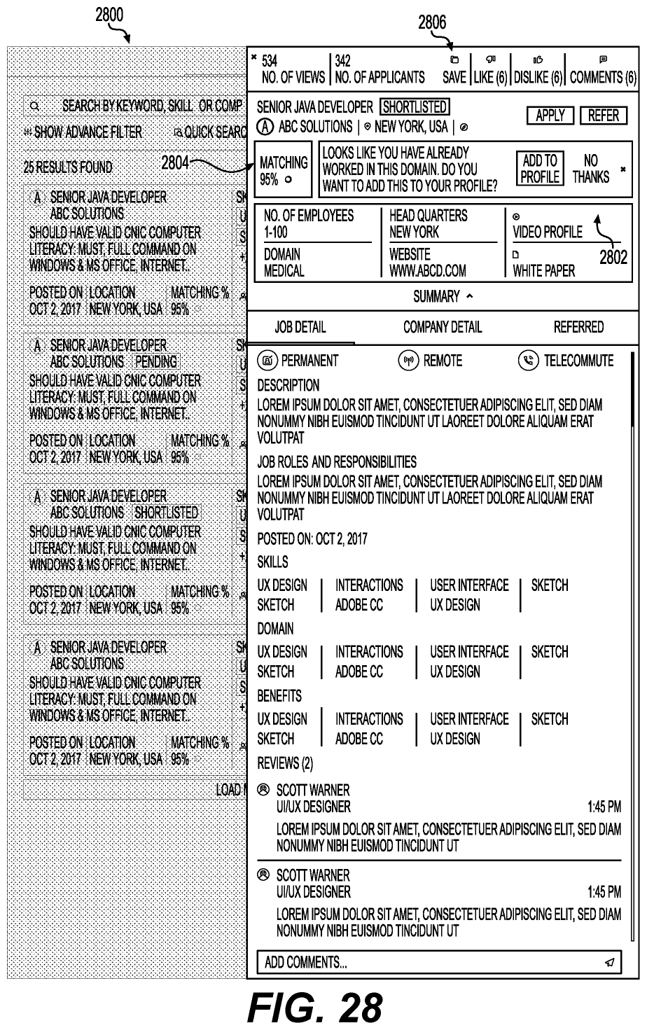

FIG. 28 illustrates another example detailed view 2800 of a position posting according to some implementations. In the current example, the system is suggesting an update or edit to the user's profile, generally indicated by 2802, based on the user's known past work experience and the selected job requirements associated with the position. In this manner, the system is able to help the user improve the user's score 2804 with respect to the current position as well as the user's profile and desirability for companies seeking employees.

In some cases, the user may save 2806 jobs or position that they wish to return to. In other cases, the user may mark a job or position as not interested. In one implementation, the system may select jobs similar to saved positions 2806 and decline from suggestion jobs or position similar to position the user has indicated not interested in.

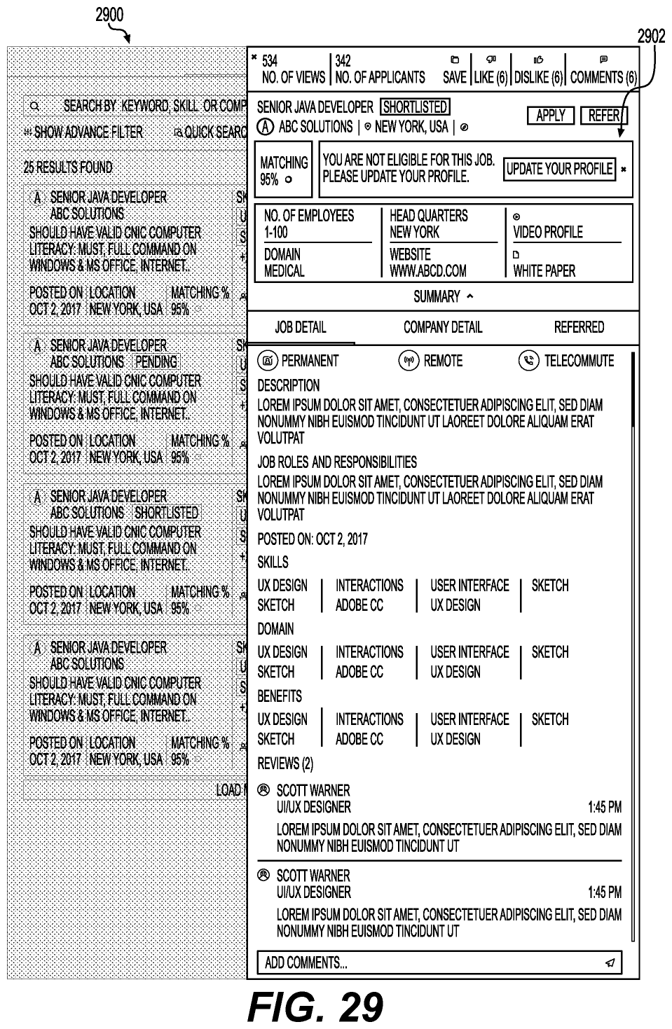

FIG. 29 illustrates yet another example detailed view 2900 of a position posting according to some implementations. In the current example, the system is providing information that the user is not eligible for the position, generally indicated by 2902. In this example, the system may direct the user to update their profile and make suggestions on how the user may become eligible. For instance, the user may be required to take a personality test, technical evaluation, or undergo a background check.

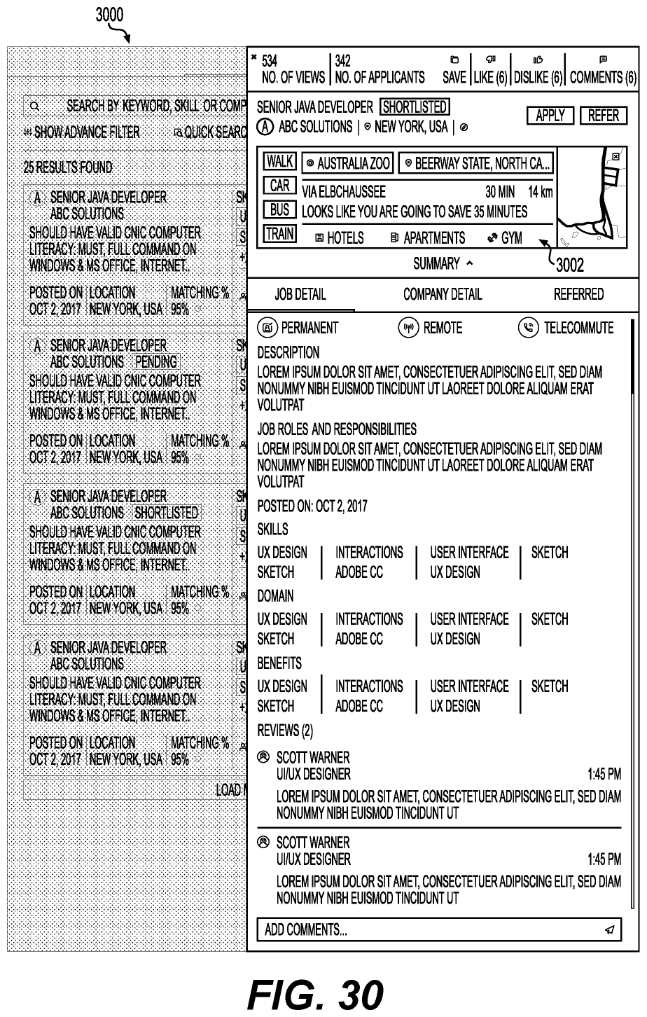

FIG. 30 illustrates yet another example detailed view 3000 of a position posting according to some implementations. In the current example, the system is presenting location and travel information 3002 between the user's home and the position's location to the user, such as walking, driving, and public transport options. In addition to location and travel information, the system may also provide information related to the city or area around the position's location, such as restaurants, activities, public services, public transportation options, etc. The system may also provide tax information (such as income and sales tax at a state level for an out of state applicant), cost of living statics, average salaries, community ratings, among others.

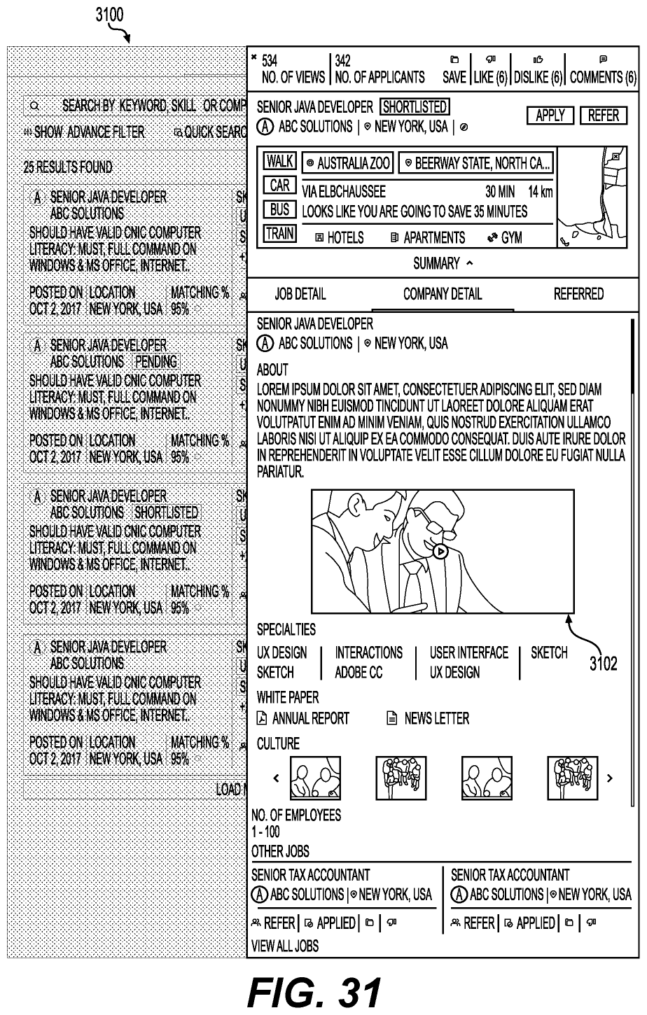

FIG. 31 illustrates yet another example detailed view 3100 of a position posting according to some implementations. In the current view, the customer that posted the position has included video information 3102 about the listing. In some examples, the user may also be able to upload video data that may be used as part of the user's profile, as part of one or more applications, or the criteria used by the system to rank the candidates.

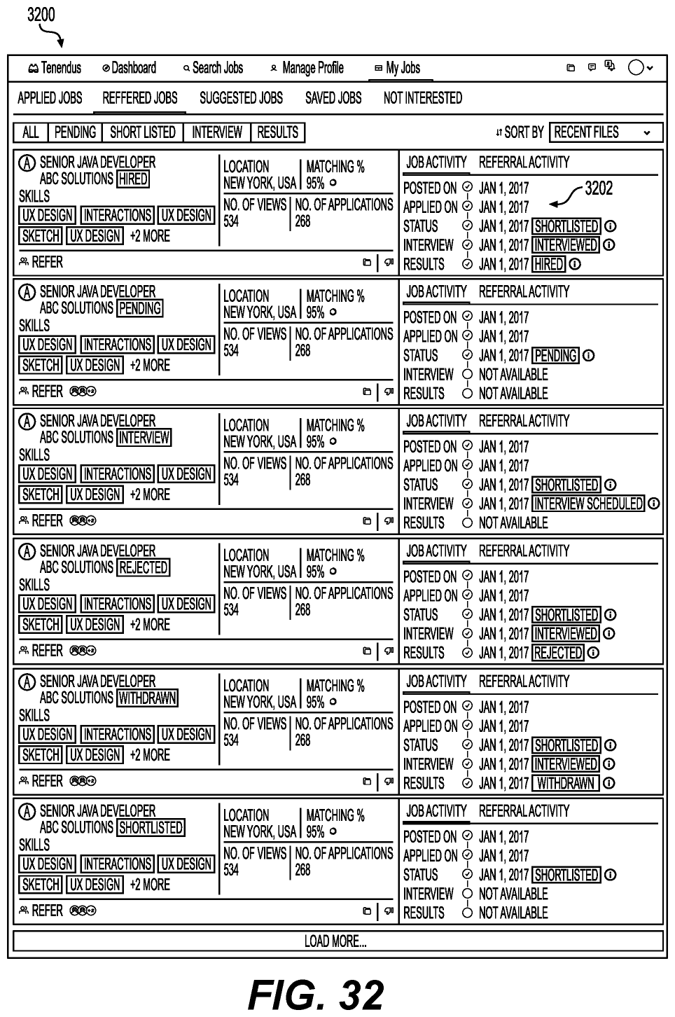

FIG. 32 illustrates an example pending position status view 3200 of a user portal according to some implementations. In this example, the user may view information related to a timeline 3202 and other information related to each position the user has applied for. For example, each item on the timeline may include a timeline having a posted date (e.g., the date a position was created), applied on date, status (such as pending, second round, additional material requested, awaiting final decision, etc.), interview (e.g., the date of the interview), and/or results (e.g., rejected or hired).

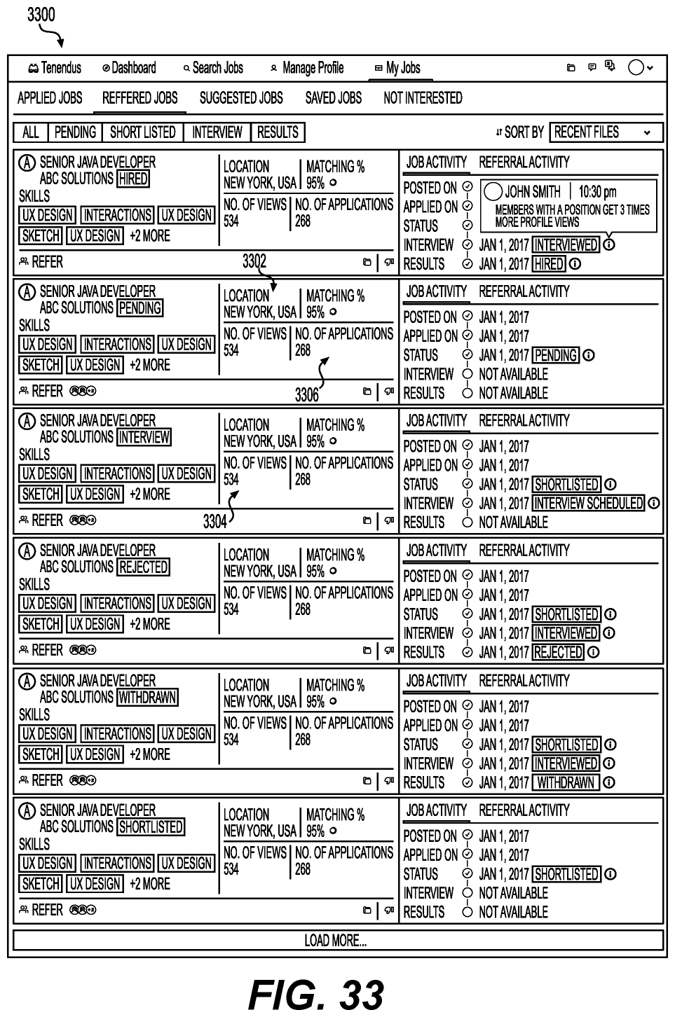

FIG. 33 illustrates an example pending position status view 3300 of a user portal according to some implementations. In the current example, the system presents to the user information on each position they have applied to. For example, the system may present information related to the location 3302, the number of views 3304 and the number of applicants 3306.

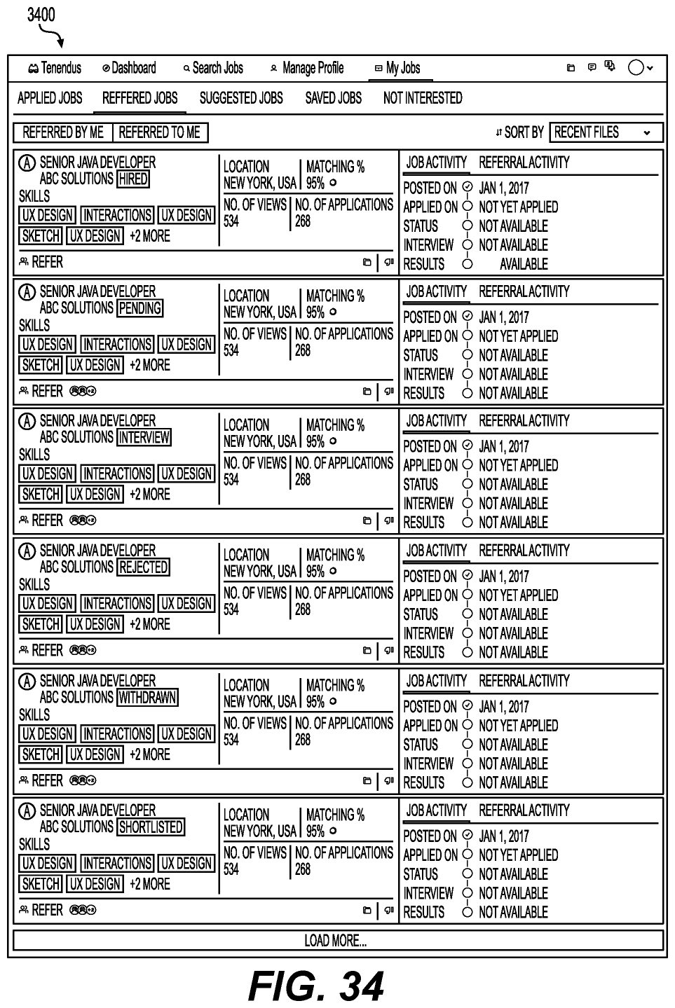

FIG. 34 illustrates an example referral view 3400 of a user portal according to some implementations. In the current example, the system may present a list of positions that the user has referred candidates to or a list of positions that have been referred to the user. In some cases, a user may view the status of each position for which the user referred a candidate and the candidate applied. In other cases, the status information may be made available only if the candidate authorized the referrer to have access to that information.

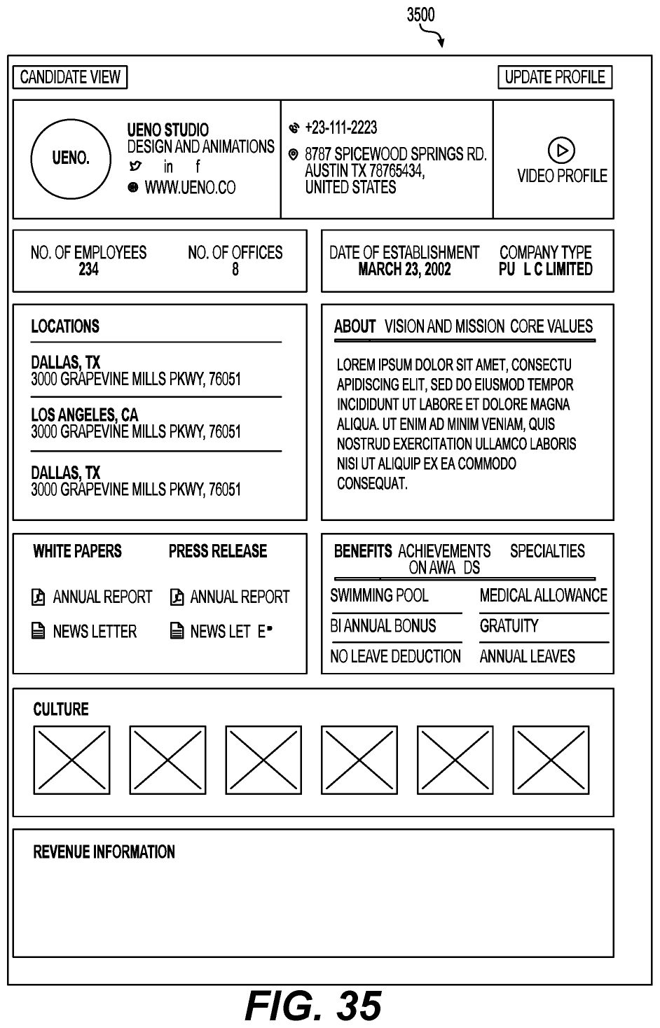

FIG. 35 illustrates an example view 3500 of a customer portal according to some implementations. In this example, the customer may enter information about the company, such as cultural views, workplace values, mission and mission statements, location of one or more offices, etc. In some cases, the view 3500 may include core values, specialties of the company, videos, audio data, news and events related to the company, among others. The view 3500 also allows the customer to provide example white papers and other information, benefits, and awards that the customer would like potential applicants to be aware of.

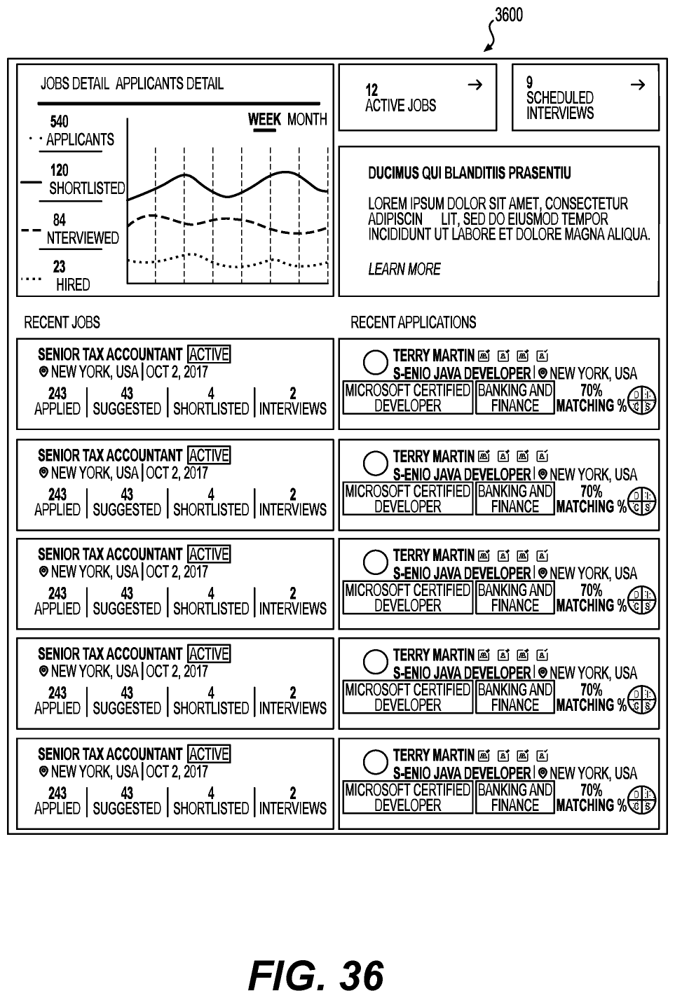

FIG. 36 illustrates an example dashboard view 3600 of a customer portal according to some implementations. The dashboard view 3600 may provide a customer, such as the human resource or hiring manager of a company, information related to the number of applications, number of open positions, number of hires, etc. The view 3600 may also provide details about various applicants and/or open positions. In some cases, the view 3600 may provide information about the number of applicants, the number of interviewed candidates, and the number of hired candidates. The hiring data may further be presented or broken down by the system by position or position type. For instance, the current example, shows via interface 3602 each listing for the senior tax accountant type position with the company.

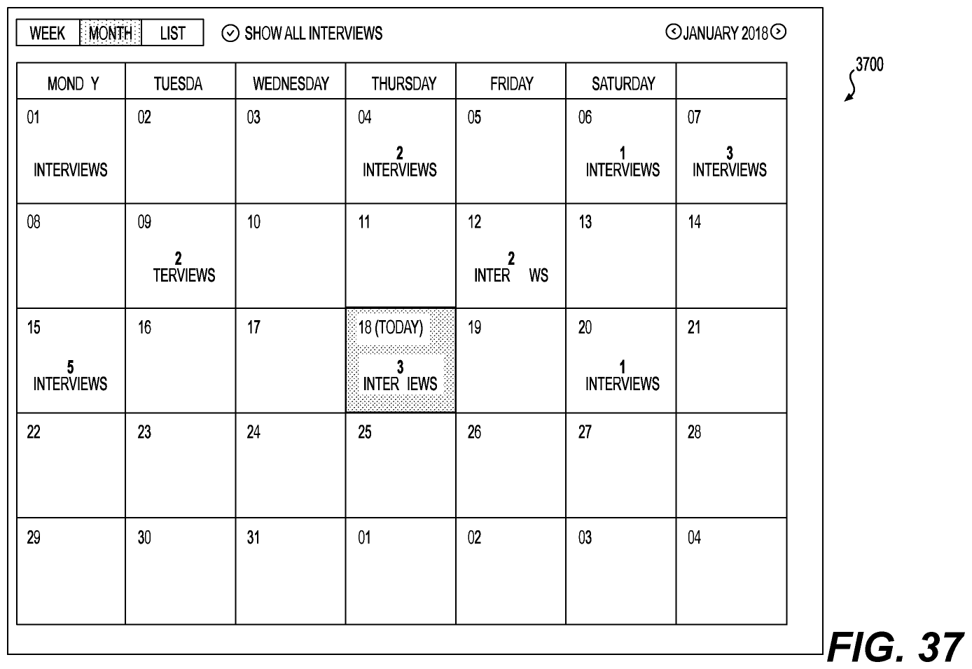

FIG. 37 illustrates a calendar view 3700 of a customer portal according to some implementations. In the view 3700, the customer may see upcoming schedule interviews or schedule various events related to a filling a position.

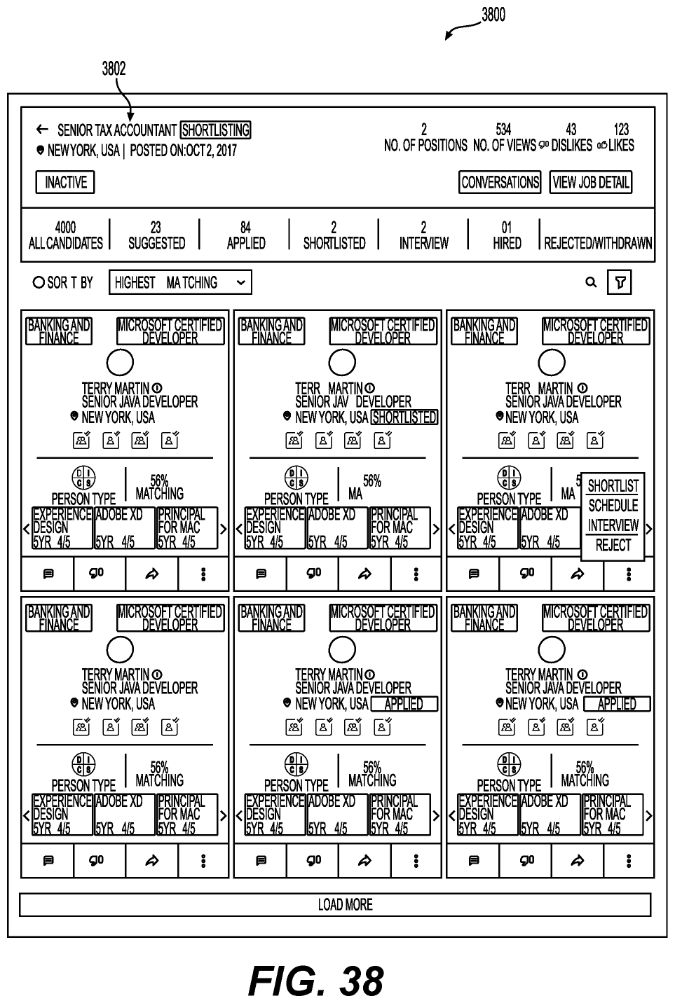

FIG. 38 illustrates an example position detail view 3800 of a customer portal according to some implementations. In the view 3800 the customer may view the various individual candidates associated with a position 3802. In some cases, the system may limit the number of applicants or only present applicants meeting predefined criteria.

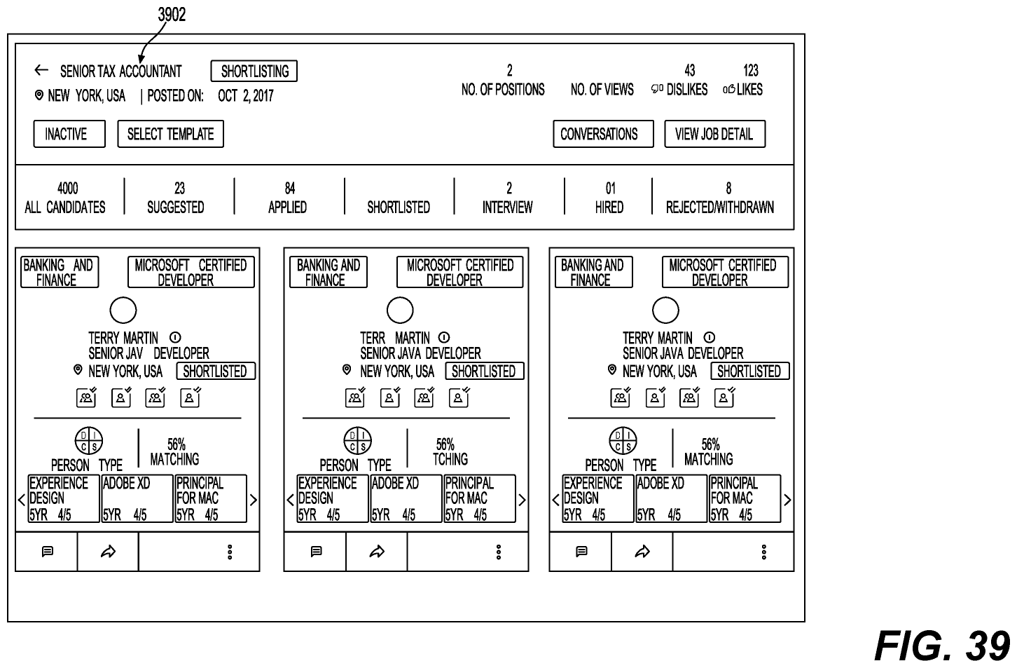

FIG. 39 illustrates another example position detail view 3900 of a customer portal according to some implementations. In the view 3900 the customer may view the various individual candidates associated with a position 3902. In some cases, the system may limit the number of applicants or only present applicants meeting predefined criteria.

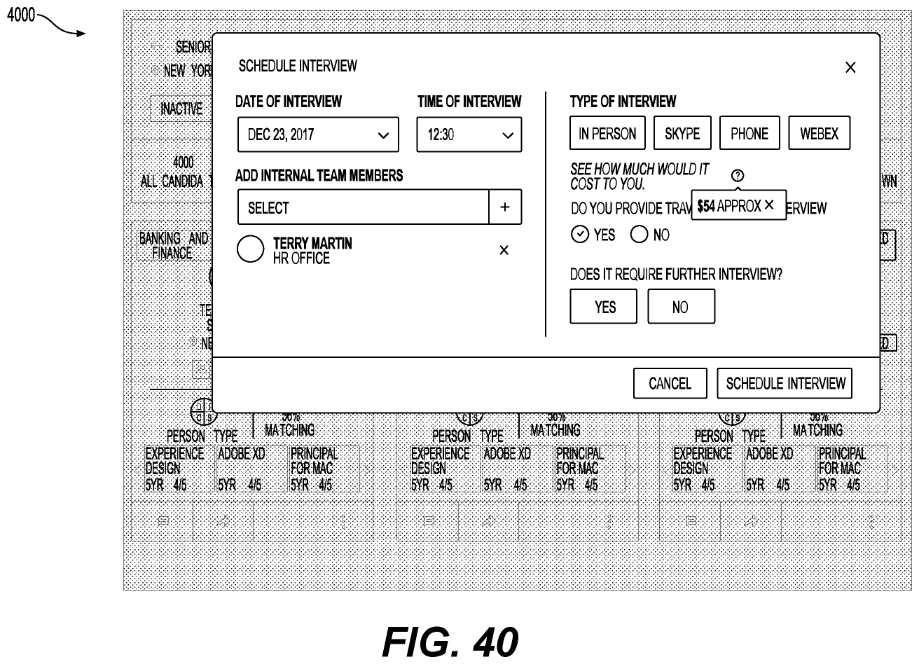

FIG. 40 illustrates an example interview scheduling view 4000 of a customer portal according to some implementations. For example, the customer may schedule an interview in various formats, such as in person, video, phone, etc.

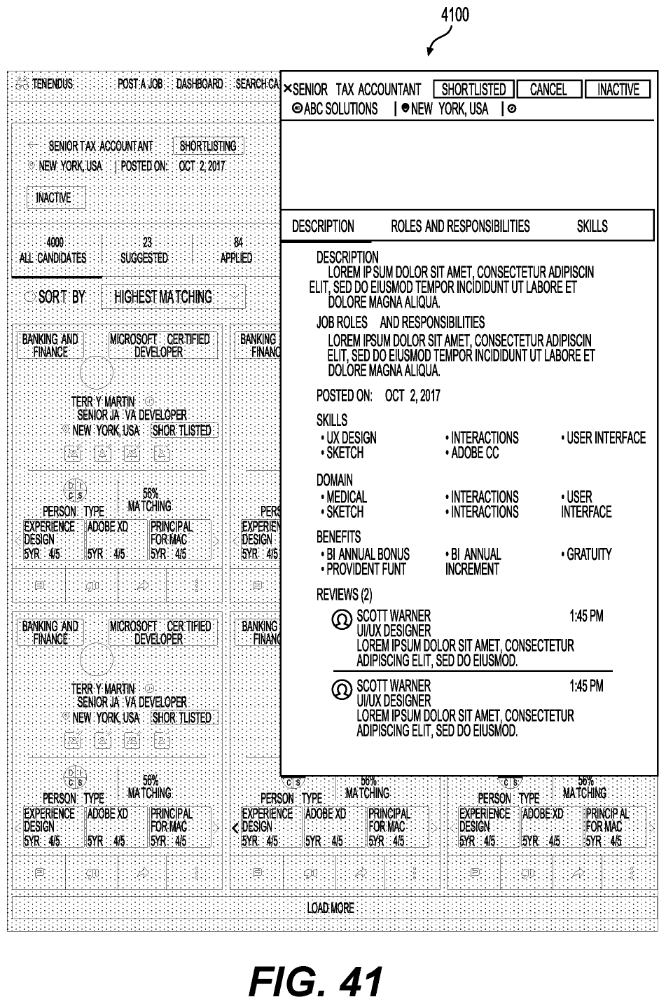

FIG. 41 illustrates an example position posting view 4100 of a customer portal according to some implementations. In this example, the customer may specific information related to a position, such as job description, roles, responsibility, skill requirements, personality, etc. In some cases, the positing may be input via audio files or voice capture.

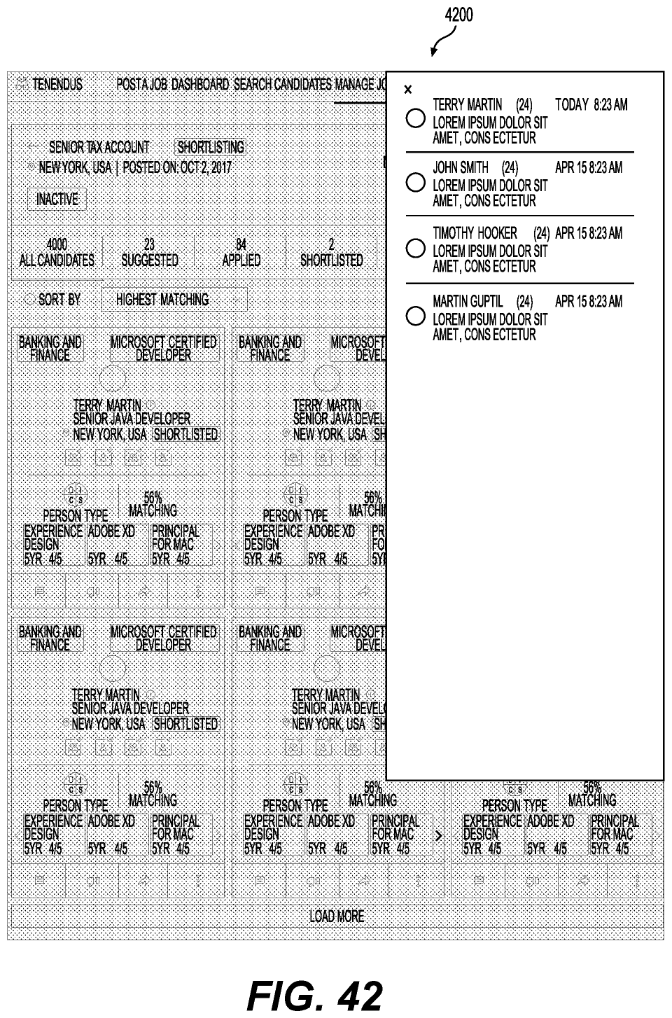

FIG. 42 illustrates an example applicant list view 4200 of a customer portal according to some implementations. In some cases, the view 4200 allows the hiring manager to order or rank the candidates in a quick list view type manner.

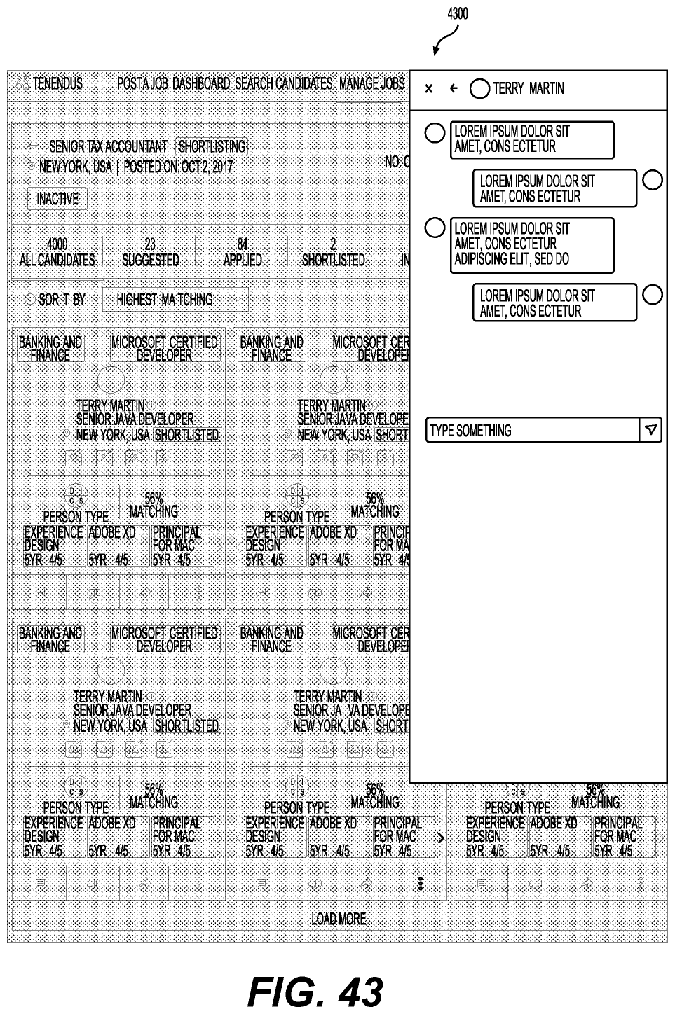

FIG. 43 illustrates an example chat view 4300 of a customer portal according to some implementations. In this example, the customer may receive all correspondence, comments, or information related to a particular candidate or position. In some cases, the correspondence, comments, or information may include the identification of the source of the correspondence, comments, or information.

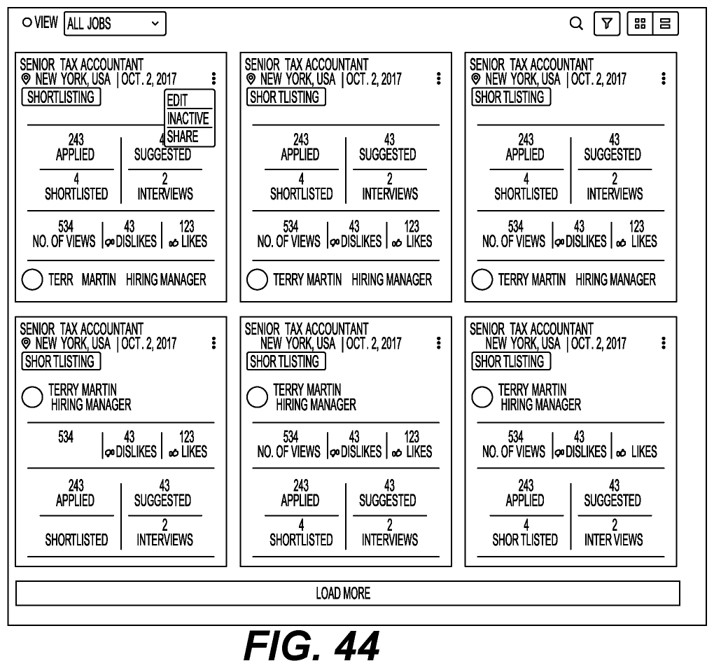

FIG. 44 illustrates an example position detail view 4400 of a customer portal according to some implementations. In the view 4400 the customer may view a list of open positions with their company. In some case, a candidate's profile may be shared via a share option between individuals associated with the customer.

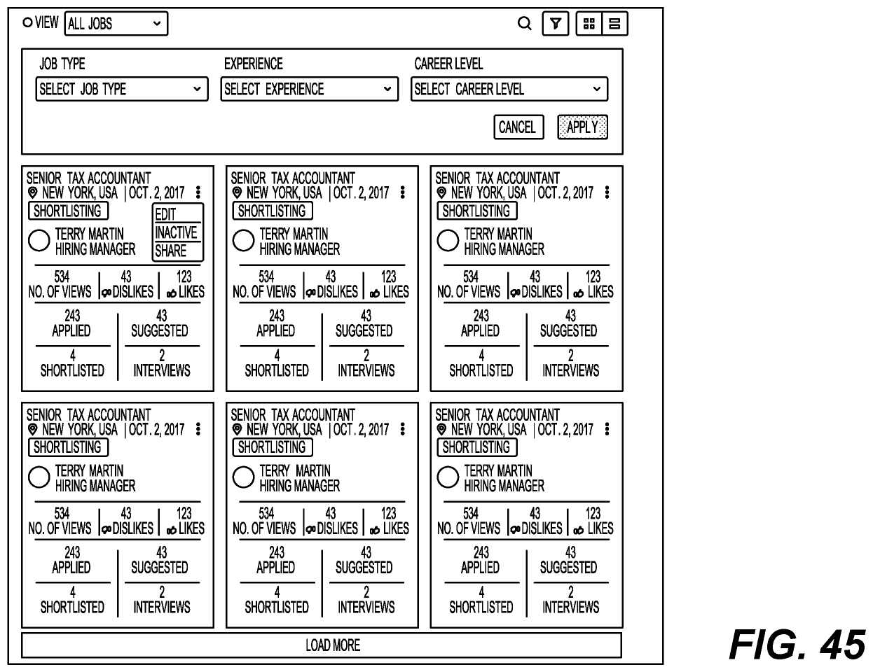

FIG. 45 illustrates another example position detail view 4500 of a customer portal according to some implementations. In the view 4500 the customer or hiring manager may view a list of open positions with their company.

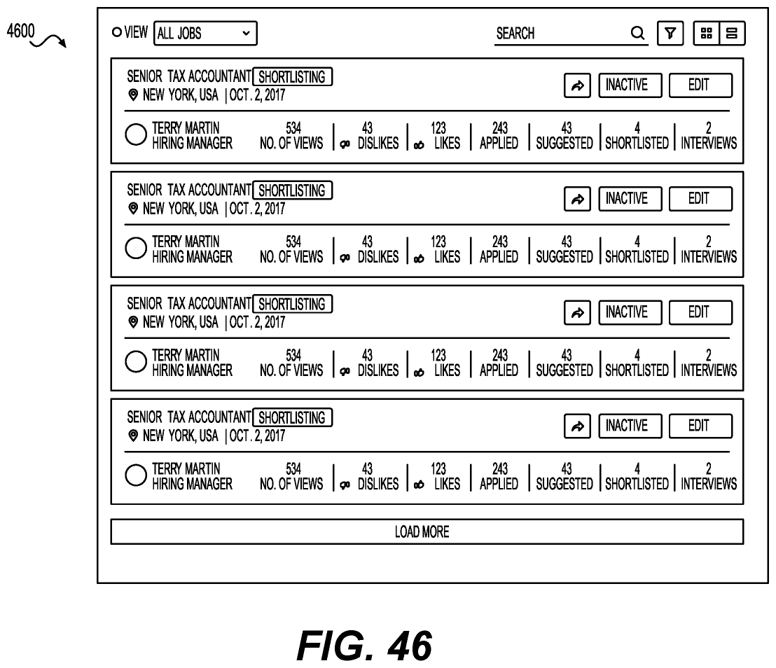

FIG. 46 illustrates yet another example position detail view 4600 of a customer portal according to some implementations. In the view 4600 the customer may view a list of open positions with their company.

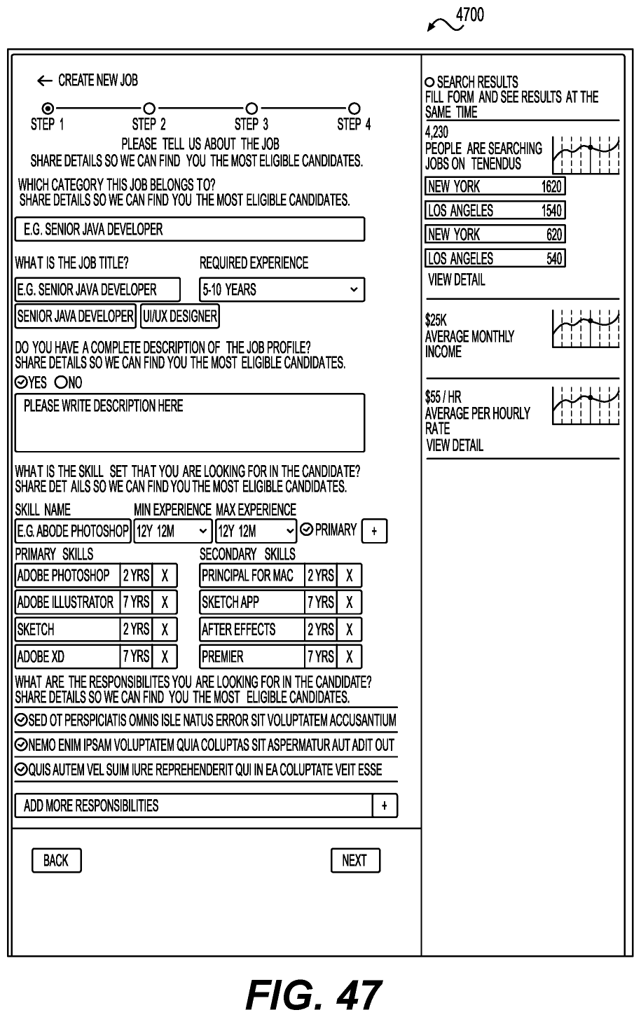

FIG. 47 illustrates a position creating view 4700 of a customer portal according to some implementations. In the current example, the customer may create a new job or position listing with the system. For instance, the customer may specify title, job requirements, skill sets, etc.

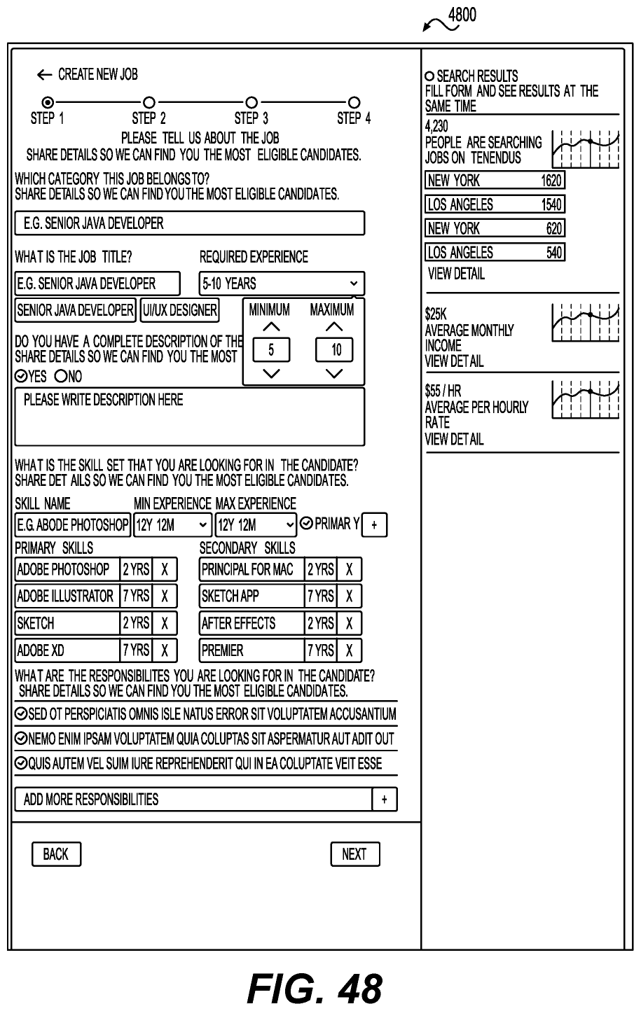

FIG. 48 illustrates another position creating view 4800 of a customer portal according to some implementations. In the current example, the customer may create a new job or position listing with the system. For instance, the customer may specify title, job requirements, skill sets, etc. In some examples, the customer may be able to include video data with a position posting. For instance, the customer may include voice questionaries, video questionaries, video pitches, video marketing materials, etc.

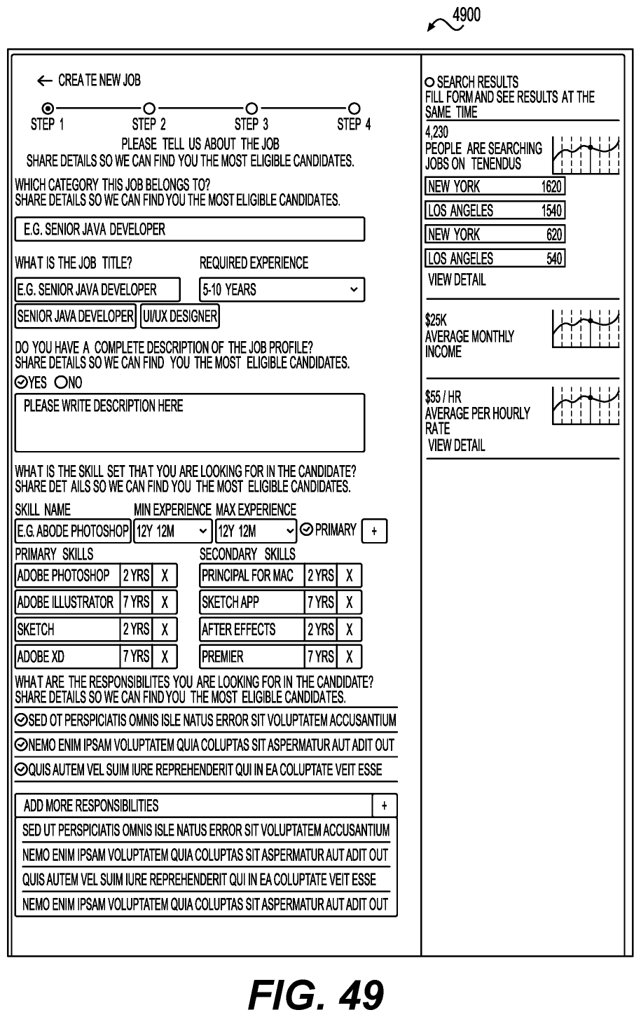

FIG. 49 illustrates yet another position creating view 4900 of a customer portal according to some implementations. In the current example, the customer may create a new job or position listing with the system. For instance, the customer may specify title, job requirements, skill sets, etc. in some cases, the system may allow the customer to upload various documents to a position posting which may be parsed to a job posting.

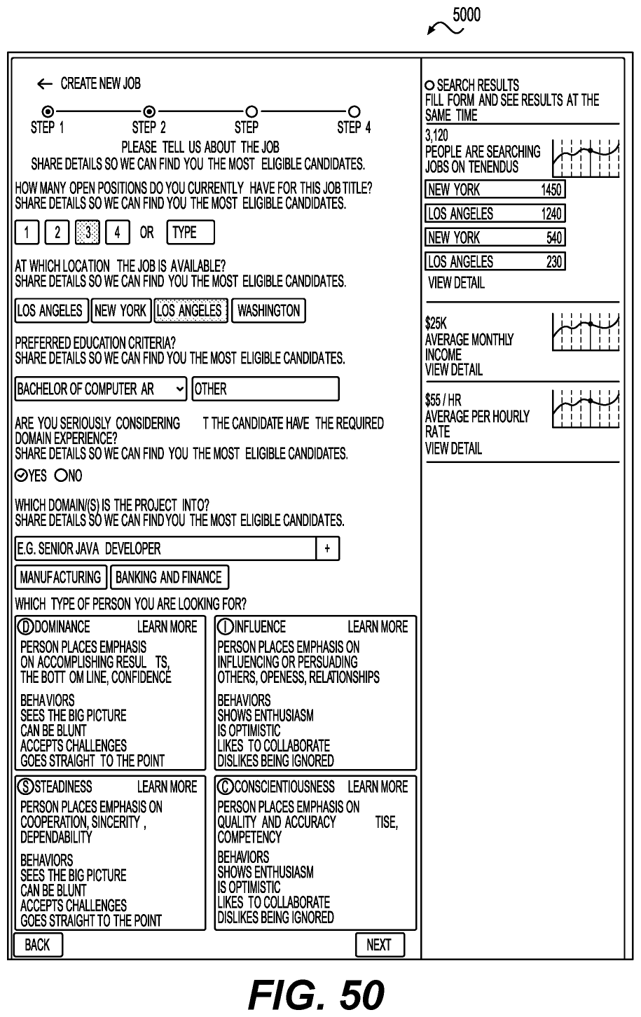

FIG. 50 illustrates yet another position creating view 5000 of a customer portal according to some implementations. In the current example, the customer may create a new job or position listing with the system. For instance, the customer may specify title, job requirements, skill sets, etc. In some examples, once a particular position has been created, the customer may utilize a quick job post option to recreate the listing or to generate a similar listing. In other cases, the customer may select a template position posting that may then be customized for a particular position.

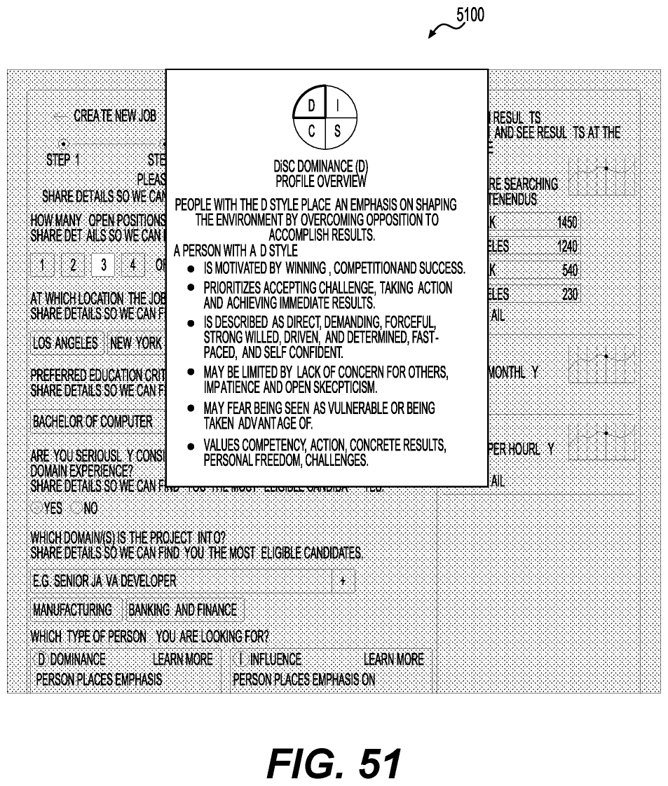

FIG. 51 illustrates a personality trait selection view 5100 of a customer portal according to some implementations. In this case, the customer may require the applicants to undergo a personality test and require the applicant to have a desired personality in order to apply for the position. In other cases, the system may allow a customer to record a voice or video interview. For instance, the system may allow the candidate to participate in a recorded interview that is the customer questions are recorded prior to the interview and output by the system while the candidate answer the question. The candidate answer can then be recorded and provided to the customer for review at a later date. In some cases, the recorded answers may be analyzed by the system to determine a best fit measures of each candidate in order to prescreen some candidates. For instance, the recording can be rated based on word usage, difficult of words, proper provocation, vocabulary, etc.

For every job posting in our system, the system may provide the number of views for that job and the number of applications received for that job. Our system will use this data to provide more analytics to the customers.

For each search result displayed on the portal, the matching percentage may be calculated and displayed, by the system, for the customer to view the candidate's suitability for the job (for logged in users/candidates)

Candidates may choose one of the given templates which may be used to share profiles to the customers in the selected template.

The platform may also be configured to allow the hiring managers and candidates to participate in interviews via the platform. Based upon their skills, background, and screening results, the system may provide ratings for customers to utilize to streamline their screening process. For each interview, candidates may receive interview incentives and ratings. This will have many other features including: Video/Audio enabled features/recordings, Options to capture interview feedback and share feedback instantly with other team members while interviewing enabling customers to make quick decisions.

In the job posting, the customer or hiring manager may indicate which personality among the four DISC results (or alternatively the five OCEAN results) is required for the position. In some cases, the system may identify candidates' DISC personality designation by capturing information from the candidates which can be utilized in matching algorithms to find the best match between candidates and jobs.

It should be understood that in some cases, the system may include a feature to capture voice inputs to analyze and to utilize the voice inputs in lieu of or in addition to physical inputs.

While FIGS. 1-51 show various views, examples, and implementations, it should be understood that the features of FIGS. 1-51 may be applicable to any of the implementations or examples illustrated. For example, the user interfaces of FIGS. 1-12 may be each be used by the recruiting system to assist with platform processes. Further, aspects of one user interface may be used in combination with other user interfaces, such that features of one interface of FIGS. 12-51 may be included on other user interfaces of FIGS. 12-51. Additionally, the processes of FIGS. 5-8 and the components of FIGS. 9 and 10 may apply to any of the systems of FIGS. 1-4 or the user interfaces of FIGS. 12-51.

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A system comprising:
one or more processors;
non-transitory computer-readable media storing computer-executable instructions, which when executed by the one or more processors cause the one or more processors to perform operations comprising:
receiving candidate data and qualification data from a user of the system, the user being a potential job candidate;
receiving position data associated with at least one open position at a company;
identifying at least one criteria for the position based at least in part on the position data;
determining that the user meets or exceeds the criteria for the position;
generating a qualification score for the user based at least in part on the position data, the candidate data, and the qualification data;
determining that the qualification score is greater than a qualification score threshold;
notifying the user that the user would be a good fit for the position via a device associated with the user;
receiving a request to apply for the position from the device; and
providing the qualification score, candidate data, and qualification data to a location accessible by a representative of the company.

2. The system as recited in claim 1, wherein the qualification data includes at least one of a background check, a Dominance, Influence, Compliance, and Steadiness, assessment, or a certification.

3. The system as recited in claim 1, wherein the operations further comprise, in response to receiving the request to apply for the position, determining at least one recommendation for the user to improve the qualification score based at least on the position data, third party data, candidate data, and qualification data and providing the recommendation to the device.

4. The system as recited in claim 3, wherein the operations further comprise receiving additional data from the device and, in response to receiving the additional data, re-calculating the qualification score prior to providing the qualification score to the location accessible to the representative of the company.

5. The system as recited in claim 1, wherein the operations further comprise, receiving a referral of the first user from a second user prior to notifying the first user that the first user would be a good fit for the position via a device.

6. The system as recited in claim 5, wherein the operations further comprise selecting the second user to receive an incentive for referring the first user for the position in response to receiving an input indicting that the first user was selected to fill the position.

7. The system as recited in claim 5, wherein the operations further comprise:
receiving a referral of the second user from a third user prior to receiving the referral of the first user from the second user;
selecting the third user to receive an incentive for referring the first user for the position in response to receiving an input indicting that the first user was selected to fill the position.

8. The system as recited in claim 5, wherein the operations further comprise:
receiving a referral of the second user from a third user prior to receiving the referral of the first user from the second user;
selecting the second user to receive an incentive for referring the first user for the position in response to receiving an input indicting that the first user was selected to fill the position.

9. The system as recited in claim 5, wherein the operations further comprise:
receiving a referral of the second user from a third user prior to receiving the referral of the first user from the second user;
selecting the second user to receive a first incentive for referring the first user for the position in response to receiving an input indicting that the first user was selected to fill the position; and
selecting the third user to receive a second incentive for referring the first user for the position in response to receiving an input indicting that the first user was selected to fill the position.

10. The system as recited in claim 5, wherein the operations further comprise:
receiving a referral of the second user from a third user prior to receiving the referral of the first user from the second user;
receiving a referral of the third user from a fourth user prior to receiving the referral of the second user from the third user;
selecting the second user to receive a first incentive for referring the first user for the position in response to receiving an input indicting that the first user was selected to fill the position; and
selecting the fourth user to receive a second incentive for referring the first user for the position in response to receiving an input indicting that the first user was selected to fill the position.

11. A method comprising:
receiving, at a recruiting system, a referral of a first user from a second to fill a position listing hosted by the recruiting system;
receiving candidate data and qualification data from the first user;
generating a qualification score for the first user with respect to the position listing based at least in part on position data associated with the position listing, the candidate data, and the qualification data;
determining that the qualification score is greater than a qualification score threshold; and
providing the qualification score, candidate data, and qualification data to a location accessible by a representative associated with the position listing.

12. The method as recited in claim 11, further comprising:
receiving an indication that the first user was selected to fill an opening associated with the position listing; and
providing an incentive to the second user.

13. The method as recited in claim 11, further comprising:
receiving an indication that the first user was not selected to fill an opening associated with the position listing;
determining at least one recommendation for the first user to improve the qualification score based at least on the position data, third party data, candidate data, and qualification data and providing the recommendation to the device, in response to receiving the indication that the first user was not selected; and
providing the recommendation to the first user.

14. The method as recited in claim 13, further comprising:
receiving additional data from the first user in response to the recommendation;
re-calculating the qualification score based at least in part on the additional data; and
re-providing the qualification score, candidate data, and qualification data to a location accessible by a representative associated with the position listing the prior to providing the qualification score to the location accessible to the representative of the company

15. The method as recited in claim 11, further comprising:
identifying a plurality of similar position listings to the position listing;
determining at least one recommendation for the representative associated with the position listing to improve the position listing based at least on the position data and aggregated data associated with the plurality of similar position listing and result data associated with the plurality of similar position listing; and
providing the recommendation to the representative associated with the position listing.

16. A method comprising:
receiving position data associated with at least one open position at a company;
identifying at least one criteria for the position based at least in part on the position data;
receiving candidate data and qualification data from a plurality of users of the system, each of the plurality of users indicting an interest in applying for the position listing;
determining that a subset of the plurality of users meets or exceeds the criteria for the position;
generating a qualification score for each of the subset of plurality of users based at least in part on the position data, the candidate data, and the qualification data;
determining that the qualification score is greater than a qualification score threshold for a set of users of the subset of the plurality of users; and
providing the qualification score, candidate data, and qualification data to a location accessible by a representative of the company for each user of the set of users.

17. The method as recited in claim 16, wherein the candidate data includes career history, awards, demographic information, and educational history and the qualification data includes background check and certifications.

18. The method as recited in claim 16, wherein the qualification data includes background check and certifications.

19. The method as recited in claim 16, wherein receiving candidate data and qualification data includes:
receiving and parsing a resume uploaded to a recruiting system by a user.

20. The method as recited in claim 16, wherein the candidate data includes at least one video.
